(19) United States
(12) Patent Application Publication
(10) Pub. No.: US 2026/0018966 A1
(43) Pub. Date: Jan. 15, 2026

(54) ROTOR AND COMPRESSOR

(71) Applicant: DENSO CORPORATION, Kariya-city (JP)

(72) Inventors: Ryo MITANI, Kariya-city (JP); Naoto NATSUME, Kariya-city (JP); Masayuki ECHIZEN, Kariya-city (JP); Masayuki TAKAHASHI, Kariya-city (JP)

(73) Assignee: DENSO CORPORATION, Kariya-city (JP)

(21) Appl. No.: 19/337,431

(22) Filed: Sep. 23, 2025

Related U.S. Application Data
(63) Continuation of application No. PCT/JP2023/046773, filed on Dec. 26, 2023.

(30) Foreign Application Priority Data
Mar. 24, 2023 (JP) 2023-049052

(51) Int. Cl. H02K 7/04; H02K 1/2753

(52) U.S. Cl. CPC H02K 7/04; H02K 1/2753

(57) ABSTRACT

A rotor includes a rotor core, a first balancing weight, and a second balancing weight. The first balancing weight is provided on an end surface on one side in an axial direction of the rotor core. The second balancing weight is provided on an end surface on another side in the axial direction of the rotor core.

### CROSS-REFERENCE TO RELATED APPLICATION

The present application is a continuation application of International Application No. PCT/JP2023/046773, filed on Dec. 26, 2023, which claims priority to Japanese Patent Application No. 2023-049052, filed on Mar. 24, 2023. The contents of these applications are incorporated herein by reference in their entirety.

### BACKGROUND

The present disclosure relates to a rotor and a compressor. A scroll-type compressor is known.

### SUMMARY

One aspect of the present disclosure provides a rotor that includes a rotor core, a first balancing weight provided on an end surface on one side in an axial direction of the rotor core, and a second balancing weight provided on an end surface on another side in the axial direction of the rotor core.

A second aspect of the present disclosure provides a compressor that includes a motor unit and a compressor unit provided on one side in the axial direction of the motor unit, in which the motor unit includes a motor housing, a stator fixed to an inner side of the motor housing, a rotor rotatably provided on an inner side of the stator, and a shaft provided in a center portion of the rotor; the compressor unit includes a compressor housing assembled to the motor housing, a fixed scroll fixed on an inner side of the compressor housing, and a movable scroll fixed to the shaft in an eccentric state and turnably provided relative to the fixed scroll; the rotor includes a rotor core and a balancing weight provided on an end surface on one side in an axial direction of the rotor core; the balancing weight has a fixing portion fixed to an end surface on one side in the axial direction of the rotor core, an axial-direction extending portion extending from an end portion on one side in an axial direction of the fixing portion toward one side in the axial direction of the rotor core, and a radial-direction extending portion extending from an end portion on a tip end side of the axial-direction extending portion toward an outer side in a radial direction of the rotor core; and the radial-direction extending portion is disposed in a space between the stator and the compressor housing in an axial direction of the motor unit.

### BRIEF DESCRIPTION OF THE DRAWINGS

In the accompanying drawings:

FIG. 1 is a longitudinal cross-sectional view of main sections of a compressor including a rotor according to an embodiment of the present disclosure;

FIG. 2 is an exploded perspective view of the rotor according to the embodiment of the present disclosure;

FIG. 3 is a perspective view of the rotor according to the embodiment of the present disclosure;

FIG. 4 is a perspective view of a first balancing weight according to the embodiment of the present disclosure;

FIG. 5 is a two-view orthographic projection of the first balancing weight according to the embodiment of the present disclosure;

FIG. 6 is a diagram of a rotor core according to the embodiment of the present disclosure, viewed from one side in an axial direction;

FIG. 7 is a graph showing a relationship between a thickness of a second balancing weight and a rotational imbalance correction amount according to the embodiment of the present disclosure;

FIG. 8 is a graph showing a relationship between the thickness of the second balancing weight and a moment imbalance correction amount according to the embodiment of the present disclosure;

FIG. 9 is a diagram comparing axial lengths of two types of rotors;

FIG. 10 is a longitudinal cross-sectional view of a first modification of a combination of the first balancing weight and the second balancing weight;

FIG. 11 is a longitudinal cross-sectional view of a second modification of the combination of the first balancing weight and the second balancing weight;

FIG. 12 is a longitudinal cross-sectional view of a third modification of the combination of the first balancing weight and the second balancing weight;

FIG. 13 is a longitudinal cross-sectional view of a fourth modification of the combination of the first balancing weight and the second balancing weight;

FIG. 14 is a longitudinal cross-sectional view of a fifth modification of the combination of the first balancing weight and the second balancing weight;

FIG. 15 is a perspective view of a first modification of a shape of the first balancing weight;

FIG. 16 is a perspective view of a second modification of the shape of the first balancing weight;

FIG. 17 is a perspective view of a third modification of the shape of the first balancing weight;

FIG. 18 is a perspective view of a fourth modification of the shape of the first balancing weight;

FIG. 19 is a perspective view of a fifth modification of the shape of the first balancing weight;

FIG. 20 is a perspective view of a sixth modification of the shape of the first balancing weight;

FIG. 21 is a perspective view of a seventh modification of the shape of the first balancing weight;

FIG. 22 is a longitudinal cross-sectional view of a modification of a configuration of a negative balance portion;

FIG. 23 is a graph showing a relationship between a depth of a first negative balance portion and the rotational imbalance correction amount;

FIG. 24 is a graph showing a relationship between the depth of the first negative balance portion and the moment imbalance correction amount;

FIG. 25 is a diagram of a rotor core showing a first modification of a shape of the negative balance portion, viewed from one side in the axial direction;

FIG. 26 is a diagram of a rotor core showing a second modification of the shape of the negative balance portion, viewed from one side in the axial direction;

FIG. 27 is a diagram of a first modification of a fixing portion of the first balancing weight;

FIG. 28 is a diagram of a second modification of the fixing portion of the first balancing weight;

FIG. 29 is an exploded perspective view of a first modification of a configuration of the rotor;

FIG. 30 is a perspective view of a second modification of the configuration of the rotor; and

FIG. 31 is a longitudinal cross-sectional view of an example of a scroll-type compressor.

### DESCRIPTION OF THE EMBODIMENTS

JP 2020-105933 A discloses a scroll-type compressor.

As a result of detailed examination by the inventors, an issue has been found in that easy correction of imbalance in a rotating body including a rotor may be desired regarding the scroll-type compressor.

In addition, as a result of detailed examination by the inventors, an issue has been found in that suppression of size increase in an axial direction, even if a balancing weight is provided, may be desired for a scroll-type compressor.

According to a first perspective of the present disclosure, it is desired to provide a rotor in which imbalance in a rotating body including the rotor can be easily corrected.

According to a second perspective of the present disclosure, it is desired to provide a compressor in which size increase in an axial direction can be suppressed even if a balancing weight is provided.

A first exemplary embodiment of the present disclosure is a rotor that includes a rotor core, a first balancing weight provided on an end surface on one side in an axial direction of the rotor core, and a second balancing weight provided on an end surface on another side in the axial direction of the rotor core.

According to the first exemplary embodiment, a rotor in which imbalance in a rotating body including the rotor can be easily corrected is provided.

A second exemplary embodiment of the present disclosure is a compressor that includes a motor unit and a compressor unit provided on one side in the axial direction of the motor unit, in which the motor unit includes a motor housing, a stator fixed to an inner side of the motor housing, a rotor rotatably provided on an inner side of the stator, and a shaft provided in a center portion of the rotor; the compressor unit includes a compressor housing assembled to the motor housing, a fixed scroll fixed on an inner side of the compressor housing, and a movable scroll fixed to the shaft in an eccentric state and turnably provided relative to the fixed scroll; the rotor includes a rotor core and a balancing weight provided on an end surface on one side in an axial direction of the rotor core; the balancing weight has a fixing portion fixed to an end surface on one side in the axial direction of the rotor core, an axial-direction extending portion extending from an end portion on one side in an axial direction of the fixing portion toward one side in the axial direction of the rotor core, and a radial-direction extending portion extending from an end portion on a tip end side of the axial-direction extending portion toward an outer side in a radial direction of the rotor core; and the radial-direction extending portion is disposed in a space between the stator and the compressor housing in an axial direction of the motor unit.

According to the second exemplary embodiment, a compressor in which size increase in an axial direction can be suppressed even if a balancing weight is provided is provided.

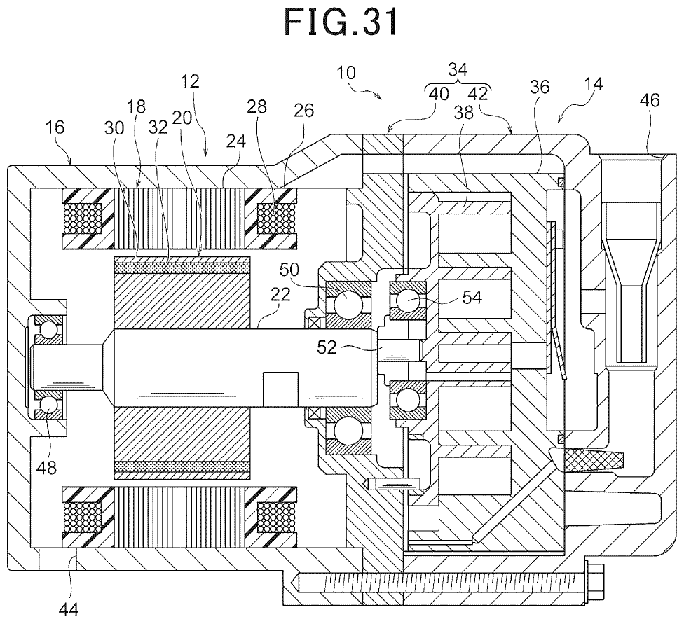

FIG. 31 is a longitudinal cross-sectional view of an example of a scroll-type compressor 10. The compressor 10 includes a motor unit 12 and a compressor unit 14 provided on one side in an axial direction of the motor unit 12.

The motor unit 12 includes a motor housing 16, a stator 18 fixed on an inner side of the motor housing 16, a rotor 20 rotatably provided on an inner side in a radial direction of the stator 18, and a shaft 22 provided in a center portion of the rotor 20.

The stator 18 includes a stator core 24, an insulator 26 mounted to the stator core 24, and a winding wound around the stator core 24 with the insulator 26 therebetween. The rotor 20 includes a rotor core 30 and a rotor magnet 32 provided in a portion on an outer circumferential surface side of the rotor core 30.

The compressor unit 14 includes a compressor housing 34, a fixed scroll 36 fixed on an inner side of the compressor housing 34, and a movable scroll 38 turnably provided relative to the fixed scroll 36. The compressor housing 34 includes a first housing 40 assembled to the motor housing 16 and a second housing 42 provided on one side in the axial direction of the first housing 40.

An inlet opening 44 is formed in the motor housing 16. A discharge opening 46 is formed in the second housing 42. A space between the fixed scroll 36 and the movable scroll 38 is formed as a compression chamber. The inlet opening 44 communicates with the compression chamber through a space on the inner side of the motor housing 16 and the like. The compression chamber communicates with the discharge opening 46 through a flow path formed in the second housing 42 and the like.

A first bearing 48 is provided in the motor housing 16 and a second bearing 50 is provided in the first housing 40. The shaft 22 is rotatably supported by the first bearing 48 and the second bearing 50. An eccentric shaft 52 is provided in an end portion on one side in the axial direction of the shaft 22. A third bearing 54 is provided in the movable scroll 38. The movable scroll 38 is fixed to the shaft 22 in an eccentric state by the eccentric shaft 52 being rotatably supported by the third bearing 54.

In the compressor 10 configured as described above, when the stator 18 forms a rotating magnetic field, the shaft 22 rotates integrally with the rotor 20. In addition, the movable scroll 38 turns in accompaniment with the rotation of the shaft 22, thereby changing a capacity of the compression chamber. A fluid drawn into the compression chamber from the inlet opening 44 is compressed in the compression chamber. Then, the compressed fluid is discharged from the discharge opening.

In the compressor 10 shown in FIG. 31, the movable scroll 38 is fixed to the shaft 22 in an eccentric state. Therefore, an imbalance (that is, a state in which a center of gravity of the rotating body is shifted from a rotational axis) occurs in the rotating body including the movable scroll 38, the rotor 20, and the shaft 22. As a method of suppressing the imbalance in the rotating body, correcting the imbalance by attaching a balancing weight to the shaft 22 or the rotor 20 can be considered.

However, the imbalance in the rotating body is difficult to correct by merely attaching a single balancing weight to the shaft 22 or the rotor 20. In addition, when the balancing weight is attached to the shaft 22 or the rotor 20, suppressing increase in size of the compressor 10 in the axial direction as a result of the balancing weight being provided is desired.

According to a first perspective of the present embodiment, it is thus desired to provide a rotor in which imbalance in the rotating body including the rotor can be easily corrected.

According to a second perspective of the present embodiment, it is thus desired to provide a compressor in which size increase in an axial direction can be suppressed even if a balancing weight is provided.

A first aspect of the present embodiment provides a rotor that includes a rotor core, a first balancing weight provided on an end surface on one side in an axial direction of the rotor core, and a second balancing weight provided on an end surface on another side in the axial direction of the rotor core.

According to the first aspect of the present embodiment, the rotor core includes the first balancing weight provided on the end surface on one side in the axial direction of the rotor core and the second balancing weight provided on the end surface on the other side in the axial direction of the rotor core. Therefore, imbalance in the rotating body including the rotor can be corrected by both the first balancing weight and the second balancing weight. Consequently, for example, compared to a case in which the rotor core includes only either of the first balancing weight and the second balancing weight, the imbalance in the rotating body can be easily corrected.

A second aspect of the present embodiment provides the rotor according to the first aspect of the present embodiment, in which the first balancing weight includes a first fixing portion fixed to the end surface on one side in the axial direction of the rotor core and a first axial-direction extending portion extending from an end portion on an outer peripheral side of the first fixing portion toward one side in the axial direction of the rotor core.

According to the second aspect of the present embodiment, the first balancing weight has the first fixing portion fixed to the end surface on one side in the axial direction of the rotor core and the first axial-direction extending portion extending from the end portion on the outer peripheral side of the first fixing portion toward one side in the axial direction of the rotor core. Therefore, for example, imbalance in the rotating body can be corrected by adjusting a length of the first fixing portion along a radial direction of the rotor core, a length of the first axial-direction extending portion along the axial direction of the rotor core, and the like. Consequently, imbalance in the rotating body can be easily corrected.

A third aspect of the present embodiment provides the rotor according to the second aspect of the present embodiment, in which the first balancing weight has a first radial-direction extending portion extending from an end portion on a tip end side of the first axial-direction extending portion toward an outer side in the radial direction of the rotor core.

According to the third aspect of the present embodiment, the first balancing weight has the first radial-direction extending portion extending from the end portion on the tip end side of the first axial-direction extending portion toward the outer side in the radial direction of the rotor core. Therefore, for example, imbalance in the rotating body can be corrected by adjusting a length of the first radial-direction extending portion along the radial direction of the rotor core and the like. Consequently, imbalance in the rotating body can be easily corrected.

A fourth aspect of the present embodiment provides the rotor according to the third aspect of the present embodiment, in which the length of the first radial-direction extending portion along the radial direction of the rotor core is longer than the length of the first axial-direction extending portion along the axial direction of the rotor core.

According to the fourth aspect of the present embodiment, the length of the first radial-direction extending portion along the radial direction of the rotor core is longer than the length of the first axial-direction extending portion along the axial direction of the rotor core. Therefore, for example, compared to a case in which the length of the first radial-direction extending portion is shorter than the length of the first axial-direction extending portion, an imbalance correction amount by the first balancing weight can be increased.

A fifth aspect of the present embodiment provides the rotor according to any one of the second aspect to the fourth aspect of the present embodiment, in which a thickness of the first fixing portion along the axial direction of the rotor core is thinner than a thickness of the second balancing weight along the axial direction of the rotor core.

According to the fifth aspect of the present embodiment, the thickness of the first fixing portion along the axial direction of the rotor core is thinner than the thickness of the second balancing weight along the axial direction of the rotor core. Therefore, for example, compared to a case in which the thickness of the first fixing portion is equal to the thickness of the second balancing weight, a length of the rotor in the axial direction can be suppressed.

A sixth aspect of the present embodiment provides the rotor according to any one of the second aspect to the fifth aspect of the present embodiment, in which the first fixing portion and the first axial-direction extending portion are formed into plate shapes.

According to the sixth aspect of the present embodiment, the first fixing portion and the first axial-direction extending portion are formed into plate shapes. Therefore, the shapes of the first fixing portion and the first axial-direction extending portion can be set based on a surrounding space of the rotor core. Consequently, for example, compared to a case in which the first balancing weight is formed into a block shape, a degree of freedom in arrangement of the first balancing weight can be enhanced.

A seventh aspect of the present embodiment provides the rotor according to any one of the third aspect, the fourth aspect, and the fifth aspect or the sixth aspect dependent on the third aspect, in which the first fixing portion, the first axial-direction extending portion, and the first radial-direction extending portion are formed into plate shapes.

According to the seventh aspect of the present embodiment, the first fixing portion, the first axial-direction extending portion, and the first radial-direction extending portion are formed into plate shapes. Therefore, the shapes of the first fixing portion, the first axial-direction extending portion, and the first radial-direction extending portion can be set based on the surrounding space of the rotor core. Consequently, for example, compared to a case in which the first balancing weight is formed into a block shape, the degree of freedom in arrangement of the first balancing weight can be enhanced.

An eighth aspect of the present embodiment provides the rotor according to any one of the second aspect to the seventh aspect of the present embodiment, in which the first axial-direction extending portion is formed into a circular arc shape along a circumferential direction of the rotor core.

According to the eighth aspect of the present embodiment, the first axial-direction extending portion is formed into a circular arc shape along the circumferential direction of the rotor core. Therefore, for example, compared to a case in which the first axial-direction extending portion is formed into a rectangular shape, a size of the first axial-direction extending portion can be increased. As a result, the imbalance correction amount by the first balancing weight can be increased.

A ninth aspect of the present embodiment provides the rotor according to any one of the third aspect, the fourth aspect, and the fifth aspect to seventh aspect dependent on the third aspect, in which the first axial-direction extending portion and the first radial-direction extending portion are each formed into a circular arc shape along the circumferential direction of the rotor core.

According to the ninth aspect of the present embodiment, the first axial-direction extending portion and the first radial-direction extending portion are each formed into a circular arc shape along the circumferential direction of the rotor core. Therefore, for example, compared to a case in which the first axial-direction extending portion and the first radial-direction extending portion are formed into rectangular shapes, the sizes of the first axial-direction extending portion and the first radial-direction extending portion can be increased. As a result, the imbalance correction amount by the first balancing weight can be increased.

A tenth aspect of the present embodiment provides the rotor according to any one the first aspect to the ninth aspect of the present embodiment, in which the rotor core has a shaft insertion hole formed in a center portion of the rotor core and into which the shaft is inserted, and the first balancing weight has a positioning portion that positions the first balancing weight relative to the shaft.

According to the tenth aspect of the present embodiment, the rotor core has a shaft insertion hole formed in a center portion of the rotor core and into which the shaft is inserted. The first balancing weight has a positioning portion that positions the first balancing weight relative to the shaft. Therefore, the first balancing weight can be positioned relative to the shaft using the positioning portion. Consequently, for example, compared to a case in which the positioning portion is not provided, accuracy of the imbalance correction amount by the first balancing weight can be ensured.

An eleventh aspect of the present embodiment provides the rotor according to any one of the first aspect to the tenth aspect of the present embodiment, in which the rotor core has a negative balance portion formed into a hollow shape in a position eccentric from the center portion of the rotor core, toward the outer side in the radial direction of the rotor core.

According to the eleventh aspect of the present embodiment, the rotor has the negative balance portion formed into a hollow shape in a position eccentric from the center portion of the rotor core, toward the outer side in the radial direction of the rotor core. Therefore, the imbalance in the rotating body can be corrected by the negative balance portion as well, in addition to the first balancing weight and the second balancing weight. Consequently, for example, compared to a case in which the rotor core does not have the negative balance portion, the first balancing weight and the second balancing weight can be reduced in size.

A twelfth aspect of the present embodiment provides the rotor according to the eleventh aspect of the present embodiment, in which the rotor includes a rotor magnet provided in a position further toward the outer side in the radial direction of the rotor core than the negative balance portion is, and the negative balance portion is formed in a position avoiding a magnetic path generated by the rotor magnet.

According to the twelfth aspect of the present embodiment, the negative balance portion is formed in a position avoiding the magnetic path generated by the rotor magnet. Therefore, for example, compared to a case in which at least a portion of the negative balance portion is formed in the magnetic path generated by the rotor magnet, an area for the magnetic path can be secured. Consequently, deterioration of characteristics of the motor unit can be suppressed.

A thirteenth aspect of the present embodiment provides the rotor according to the eleventh aspect or the twelfth aspect of the present embodiment, in which the rotor has the rotor magnet provided in a position further toward the outer side in the radial direction of the rotor core than the negative balance portion is, and at least a portion of the negative balance portion is formed in a position corresponding to a center portion of the rotor magnet in a lateral width direction.

According to the thirteenth aspect of the present embodiment, at least a portion of the negative balance portion is formed in a position corresponding to the center portion of the rotor magnet in the lateral width direction. Therefore, at least a portion of the negative balance portion can be positioned closer to the outer side in the radial direction of the rotor core, while preventing at least a portion of the negative balance portion from being formed in the magnetic path generated by the rotor magnet. Consequently, the imbalance correction amount by the negative balance portion can be increased.

A fourteenth aspect of the present embodiment provides the rotor according to any one of the eleventh aspect to thirteenth aspect of the present embodiment, in which the rotor has a plurality of rotor magnets provided in positions further toward the outer side in the radial direction of the rotor core than the negative balance portion is, the plurality of rotor magnets are arranged to be aligned in the circumferential direction of the rotor, and at least a portion of the negative balance portion is formed in a position corresponding to a portion between adjacent rotor magnets.

According to the fourteenth aspect of the present embodiment, at least a portion of the negative balance portion is formed in a position corresponding to a portion between adjacent rotor magnets. Therefore, at least a portion of the negative balance portion can be positioned further toward the outer side in the radial direction of the rotor core, while preventing at least a portion of the negative balance portion from being formed in the magnetic path generated by the rotor magnet. Consequently, the imbalance correction amount by the negative balance portion can be increased.

A fifteenth aspect of the present embodiment provides the rotor according to any one of the eleventh aspect to the fourteenth aspect of the present embodiment, in which the negative balance portion has a first negative balance portion open on an end surface on one side in the axial direction of the rotor core and a second negative balance portion open on an end surface on the other side in the axial direction of the rotor core.

According to the fifteenth aspect of the present embodiment, the negative balance portion has the first negative balance portion open on an end surface on one side in the axial direction of the rotor core and the second negative balance portion open on the end surface on the other side in the axial direction of the rotor core. Therefore, imbalance in the rotating body can be corrected by both the first negative balance portion and the second negative balance portion. Consequently, for example, compared to a case in which only either of the first negative balance portion and the second negative balance portion is provided, the imbalance in the rotating body can be easily corrected.

A sixteenth aspect of the present embodiment provides the rotor according to any one of the third aspect to the fifteenth aspect dependent on the second aspect of the present embodiment, in which the rotor core has a magnet housing hole open on an end surface on one side in the axial direction of the rotor core and housing the rotor magnet, the magnet housing hole is sealed by the first fixing portion, and the first fixing portion has a magnet cooling hole formed in a position adjacent to the rotor magnet when viewed from the axial direction of the rotor core.

According to the sixteenth aspect of the present embodiment, the first fixing portion has the magnet cooling hole formed in a position adjacent to the rotor magnet when viewed from the axial direction of the rotor core. Therefore, the rotor magnet can be cooled by sending a fluid into the magnet cooling hole.

A seventeenth aspect of the present embodiment provides the rotor according to any one of the first aspect to the sixteenth aspect of the present embodiment, in which the second balancing weight has a second fixing portion fixed to an end surface on the other side in the axial direction of the rotor core, a second axial-direction extending portion extending from an end portion on an outer peripheral side of the second fixing portion toward the other side in the axial direction of the rotor core, and a second radial-direction extending portion extending from an end portion on a tip end side of the second axial-direction extending portion toward the outer side in the radial direction of the rotor core.

According to the seventeenth aspect of the present embodiment, the second balancing weight has the second fixing portion fixed to the end surface on the other side in the axial direction of the rotor core, the second axial-direction extending portion extending from the end portion on the outer peripheral side of the second fixing portion toward the other side in the axial direction of the rotor core, and the second radial-direction extending portion extending from the end portion on the tip end side of the second axial-direction extending portion toward the outer side in the radial direction of the rotor core. Therefore, for example, imbalance in the rotating body can be corrected by adjusting a length of the second fixing position along the radial direction of the rotor core, a length of the second axial-direction extending portion along the axial direction of the rotor core, a length of the second radial-direction extending portion along the radial direction of the rotor core, and the like. Consequently, the imbalance in the rotating body can be easily corrected.

An eighteenth aspect of the present embodiment provides a compressor that includes a motor unit and a compressor unit provided on one side in the axial direction of the motor unit, in which the motor unit includes a motor housing, a stator fixed to an inner side of the motor housing, a rotor rotatably provided on an inner side of the stator, and a shaft provided in a center portion of the rotor; the compressor unit includes a compressor housing assembled to the motor housing, a fixed scroll fixed on an inner side of the compressor housing, and a movable scroll fixed to the shaft in an eccentric state and turnably provided relative to the fixed scroll; the rotor includes a rotor core and a balancing weight provided on an end surface on one side in an axial direction of the rotor core; the balancing weight has a fixing portion fixed to an end surface on one side in the axial direction of the rotor core, an axial-direction extending portion extending from an end portion on one side in an axial direction of the fixing portion toward one side in the axial direction of the rotor core, and a radial-direction extending portion extending from an end portion on a tip end side of the axial-direction extending portion toward an outer side in a radial direction of the rotor core; and the radial-direction extending portion is disposed in a space between the stator and the compressor housing in an axial direction of the motor unit.

According to the eighteenth aspect of the present embodiment, the radial-direction extending portion is disposed in the space between the stator and the compressor housing in the axial direction of the motor unit. Here, the space between the stator and the compressor housing in the axial direction of the motor unit is dead space. Therefore, even if the balancing weight is provided, increase in size of the compressor in the axial direction can be suppressed.

A nineteenth aspect of the present embodiment is the compressor according to the eighteenth aspect of the present embodiment, in which the rotor includes an imbalance correcting portion including the balancing weight, and the imbalance correcting portion has an imbalance correction amount countering imbalance due to the movable scroll.

According to the nineteenth aspect of the present embodiment, the rotor includes the imbalance correcting portion including the balancing weight, and the imbalance correcting portion has the imbalance correction amount countering the imbalance due to the movable scroll. As a result, imbalance in the rotating body including the rotor and the movable scroll can be corrected. Consequently, occurrence of noise accompanying rotation of the rotating body and the like can be suppressed.

A twentieth aspect of the present embodiment provides the compressor according to the eighteenth aspect or the nineteenth aspect of the present embodiment, in which the stator has a stator core disposed on the outer side in the radial direction of the rotor core, a connecting portion between the axial-direction extending portion and the first fixing portion is positioned further toward an inner side than an external form of the rotor core is, and an end portion on an outer peripheral side of the radial-direction extending portion is positioned further toward an inner side than an external form of the stator core is.

According to the twentieth aspect of the present embodiment, the connecting portion between the axial-direction extending portion and the first fixing portion is positioned further toward the inner side than the external form of the rotor core is. Therefore, the first fixing portion interfering with the stator core disposed on the outer side in the radial direction of the rotor core can be suppressed. In addition, the end portion on the outer peripheral side of the radial-direction extending portion is positioned further toward the inner side than the external form of the stator core is. Therefore, the radial-direction extending portion interfering with the motor housing and the like disposed on the outer side in the radial direction of the stator core can be suppressed.

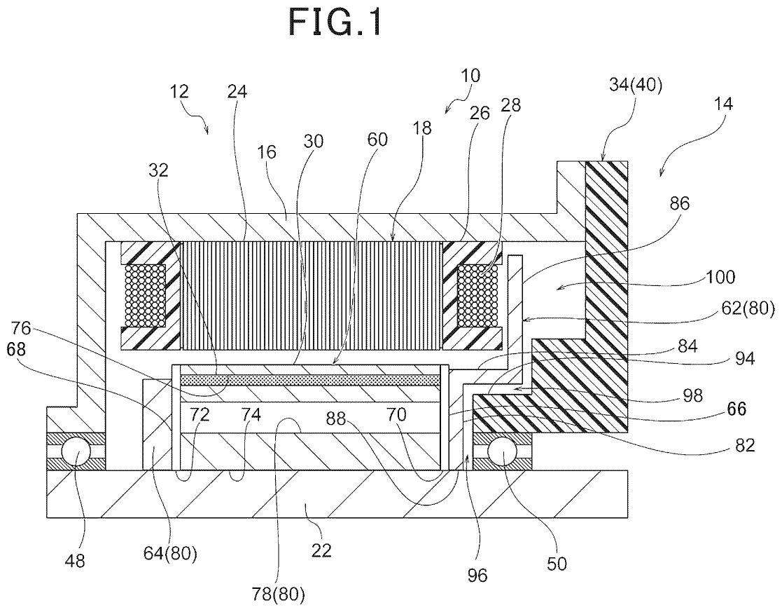

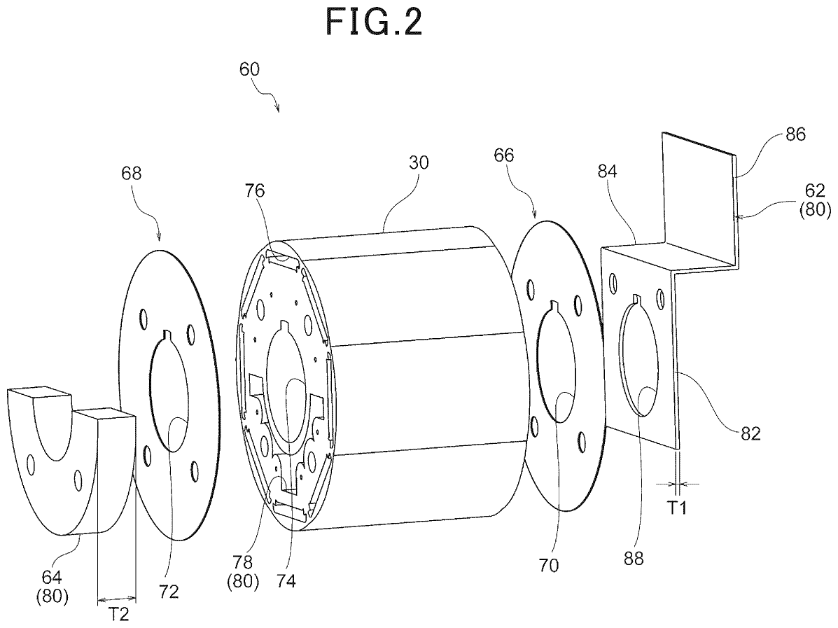

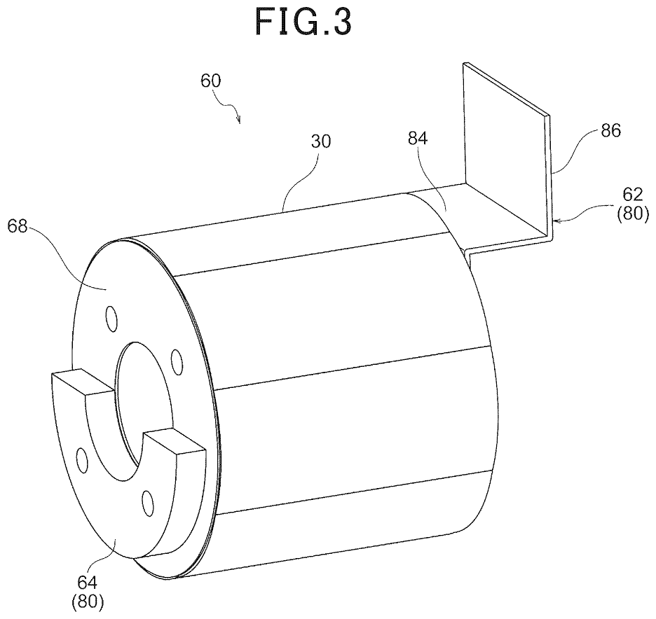

FIG. 1 is a longitudinal cross-sectional view of main sections of the compressor 10 including a rotor 60 according to the present embodiment. In the compressor 10 shown in FIG. 1, a configuration excluding the rotor 60 described hereafter is similar to that of the compressor 10 shown in FIG. 31. Therefore, the same reference numbers as those in FIG. 31 are used and descriptions are omitted. FIG. 2 is an exploded perspective view of the rotor 60 according to the present embodiment. FIG. 3 is a perspective view of the rotor 60 according to the present embodiment.

The rotor 60 includes a rotor core 30, a first balancing weight 62, a second balancing weight 64, a first cover plate 66, and a second cover plate 68. The first balancing weight 62 is an example of the “balancing weight” of the present disclosure.

The first cover plate 66 is provided on an end surface on one side in the axial direction of the rotor core 30. The second cover plate 68 is provided on an end surface on the other side in the axial direction of the rotor core 30. A shaft insertion hole 70 is formed in the first cover plate 66. A shaft insertion hole 72 is formed in the second cover plate 68. The first cover plate 66 is fixed to the shaft 22 and the rotor core 30 by the shaft 22 being pressed into the shaft insertion hole 70. In a similar manner, the second cover plate 68 is fixed to the shaft 22 and the rotor core 30 by the shaft 22 being pressed into the shaft insertion hole 72.

The first balancing weight 62 is attached to the end surface on one side in the axial direction of the rotor core 30 with the first cover plate 66 therebetween. The second balancing weight 64 is attached to the end surface on the other side in the axial direction of the rotor core 30 with the second cover plate 68 therebetween. For example, the first balancing weight 62 may be made of sheet metal and be formed into a plate shape. Meanwhile, as an example, the second balancing weight 64 is formed into a circular arc shape along the circumferential direction of the rotor 60 when viewed from the axial direction of the rotor core 30. The second balancing weight 64 is fixed to the rotor core 30 by press-fitting, crimping, or the like.

The rotor core 30 has a shaft insertion hole 74, a magnet housing hole 76, and a negative balance portion 78. The shaft insertion hole 74 is formed in a center portion of the rotor core 30 and passes through in the axial direction of the rotor core 30. The shaft 22 is inserted (for example, press-fitted) into the shaft insertion hole 74 and the rotor core 30 is thereby fixed to the shaft 22.

The magnet housing hole 76 is formed in a portion on the outer circumferential surface side of the rotor core 30 and passes through in the axial direction of the rotor core 30. The rotor magnet 32 is housed in the magnet housing hole 76. As an example, the rotor magnet 32 is a bonded magnet. The magnet housing hole 76 is sealed by the first cover plate 66 and the second cover plate 68 on both sides in the axial direction of the rotor core 30.

The first balancing weight 62, the second balancing weight 64, and the negative balance portion 78 form an imbalance correcting portion 80 that corrects imbalance in the rotating body including the rotor 60, the shaft 22, and the movable scroll 38 (see FIG. 31).

Here, in FIG. 1, for convenience, the first balancing weight 62, the second balancing weight 64, and the negative balance portion 78 are shown to be disposed in a same position in the circumferential direction of the rotor core 30. However, respective positions of the first balancing weight 62, the second balancing weight 64, and the negative balance portion 78 in the circumferential direction of the rotor core 30 are set relative to the imbalance due to the movable scroll 38 such that the first balancing weight 62, the second balancing weight 64, and the negative balance portion 78 correct the imbalance in the rotating body.

In the example shown in FIG. 1 to FIG. 3, the negative balance portion 78 passes through the rotor core 30 in the axial direction. However, the negative balance portion 78 may not pass through the rotor core 30 in the axial direction. The negative balance portion 78 is formed in a position further on the outer side in the radial direction of the rotor core 30 than the shaft insertion hole 74 and further on the inner side in the radial direction of the rotor core 30 than the magnet housing hole 76.

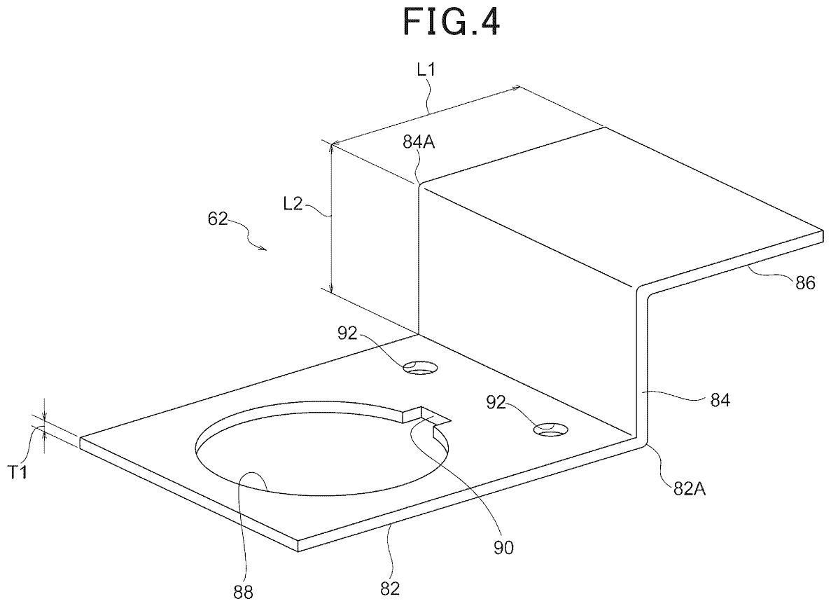

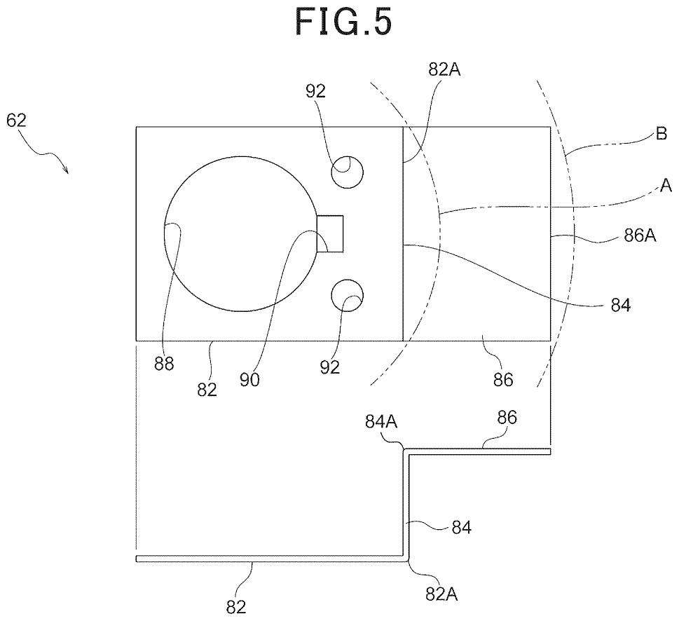

FIG. 4 is a perspective view of the first balancing weight 62 according to the present embodiment. FIG. 5 is a two-view orthographic projection of the first balancing weight 62 according to the present embodiment. The first balancing weight 62 has a fixing portion 82, an axial-direction extending portion 84, and a radial-direction extending portion 86. The fixing portion 82 is an example of the “first fixing portion” of the present disclosure. The axial-direction extending portion 84 is an example of the “first axial-direction extending portion” of the present disclosure. The radial-direction extending portion 86 is an example of the “first radial-direction extending portion” of the present disclosure.

The fixing portion 82 is fixed to the end surface on one side in the axial direction of the rotor core 30 with the first cover plate 66 therebetween. The axial-direction extending portion 84 extends from an end portion 82A on an outer peripheral side of the fixing portion 82 to one side in the axial direction of the rotor core 30. The radial-direction extending portion 86 extends from an end portion 84A on a tip end side of the axial-direction extending portion 84 toward the outer side in the radial direction of the rotor core 30.

A length L1 of the radial-direction extending portion 86 along the radial direction of the rotor core 30 is longer than a length L2 of the axial-direction extending portion 84 along the axial direction of the rotor core 30. A thickness T1 of the fixing portion 82 along the axial direction of the rotor core 30 is thinner than a thickness T2 of the second balancing weight 64 along the axial direction of the rotor core 30 (see FIG. 2).

The fixing portion 82, the axial-direction extending portion 84, and the radial-direction extending portion 86 are each formed into a rectangular shape. The fixing portion 82 has a shaft insertion hole 88. The shaft insertion hole 88 passes through in a plate thickness direction of the fixing portion 82 (that is, the axial direction of the rotor core 30). The shaft 22 is inserted (for example, press-fitted) into the shaft insertion hole 88 and the first balancing weight 62 is thereby fixed to the rotor core 30.

In addition, the fixing portion 82 has a key groove 90. The key groove 90 is formed into a shape in which a portion in a circumferential direction of the shaft insertion hole 88 is notched in a recessing shape. A protruding portion (not shown) formed in the shaft 22 is fitted into the key groove 90, and the first balancing weight 62 is thereby positioned in a rotating direction relative to the shaft 22. Here, a positioning hole 92 may be formed in the fixing portion 82. A rivet (not shown) may be inserted in to the positioning hole 92 and press-fitted into a rivet hole (not shown) formed in the rotor core 30, thereby positioning the first balancing weight 62 to the rotor core 30. The key groove 90 and the positioning hole 92 are an example of the “positioning portion” of the present disclosure.

As shown in FIG. 1, a bearing housing portion 94 housing the second bearing 50 is formed in the first housing 40. The bearing housing portion 94 has a bottom surface opposing, in the axial direction of the motor unit 12, the end surface on one side in the axial direction of the rotor core 30. The fixing portion 82 is disposed in a space 96 between the end surface on one side in the axial direction of the rotor core 30 and the bottom surface of the bearing housing portion 94.

In addition, the bearing housing portion 94 has an outer peripheral surface opposing, in the radial direction of the motor unit 12, an inner circumferential portion (that is, an inner circumferential surface of the insulator 26) of the stator 18. The axial-direction extending portion 84 is disposed in a space 98 between the inner circumferential portion of the stator 18 and the outer peripheral surface of the bearing housing portion 94. The space 98 between the inner circumferential portion of the stator 18 and the outer peripheral surface of the bearing housing portion 94 is a dead space formed between the stator 18 and the compressor housing 34 in the radial direction of the motor unit 12.

The first housing 40 has an opposing surface that opposes the stator 18 in the axial direction of the motor unit 12. The radial-direction extending portion 86 is disposed in a space 100 between the stator 18 and the opposing surface of the first housing 40. The space 100 is a dead space formed between the stator 18 and the compressor housing 34 in the axial direction of the motor unit 12.

A virtual line A shown in FIG. 5 shows an external form (that is, an outer circumferential surface) of the rotor core 30. A connecting portion between the axial-direction extending portion 84 and the fixing portion 82 (that is, the end portion 82A on the outer peripheral side of the fixing portion 82) is positioned further toward the inner side than the external form of the rotor core 30 is. In addition, a virtual line B shown in FIG. 5 shows an external form (that is, the outer circumferential surface) of the stator core 24. The end portion 86A on the outer peripheral side of the radial-direction extending portion 86 is positioned further toward the inner side than the external form of the stator core 24 is.

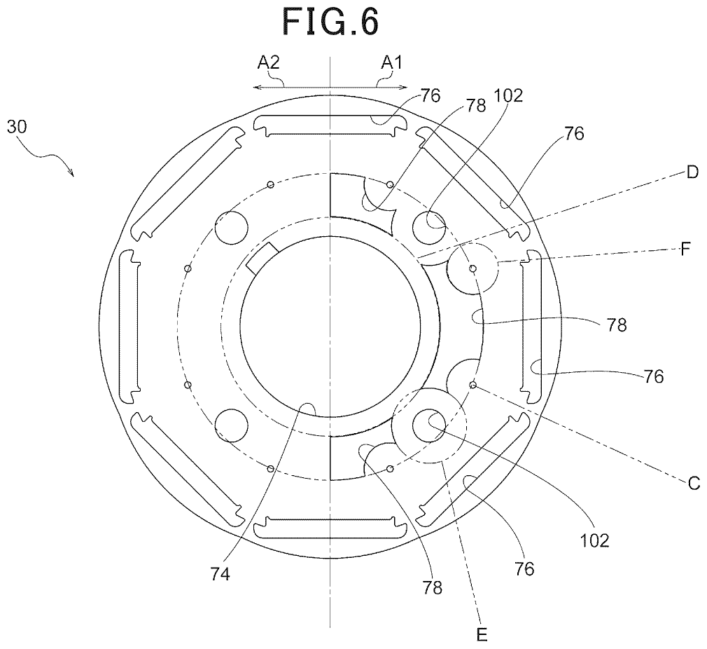

FIG. 6 is a diagram of the rotor core 30 according to the present embodiment viewed from one side in the axial direction. A plurality of magnet housing holes 76 are formed in the rotor core 30. The plurality of magnet housing holes 76 are formed in an array in the circumferential direction of the rotor core 30. Each magnet housing hole 76 extends in a tangential direction of the rotor core 30 when viewed from the axial direction of the rotor core 30. The rotor magnet 32 (see FIG. 1) is housed in the magnet housing hole 76 and thereby disposed in a position further toward the outer side in the radial direction of the rotor core 30 than the negative balance portion 78 is.

As an example, if the rotor core 30 is divided into a first area A1 and a second area A2 by a center line when viewed from the axial direction of the rotor core 30, the negative balance portion 78 is formed in the first area A1. The negative balance portion 78 is formed in a position avoiding a magnetic path generated by the rotor magnet 32. That is, a virtual line C is an outermost diameter line positioned avoiding the magnetic path generated by the rotor magnet 32. The negative balance portion 78 is formed further toward the inner side in the radial direction of the rotor core 30 than the virtual line C is. In addition, a virtual line D is an innermost diameter line in a position ensuring thickness relative to the shaft insertion hole 74. The negative balance portion 78 is formed further toward the outer side in the radial direction of the rotor core 30 than the virtual line D is.

Here, in a case in which a rivet hole 102 is formed in the rotor core 30, the negative balance portion 78 is formed in a position ensuring thickness relative to the rivet hole 102. That is, a virtual line E is an outermost diameter line in a position ensuring thickness relative to the rivet hole 102. The negative balance portion 78 is formed on the outer side of the virtual line E. In addition, a virtual line F is an outermost diameter line of a portion in which thickness is required to be ensured to secure the magnetic path. The negative balance portion 78 is formed on the outer side of the virtual line F.

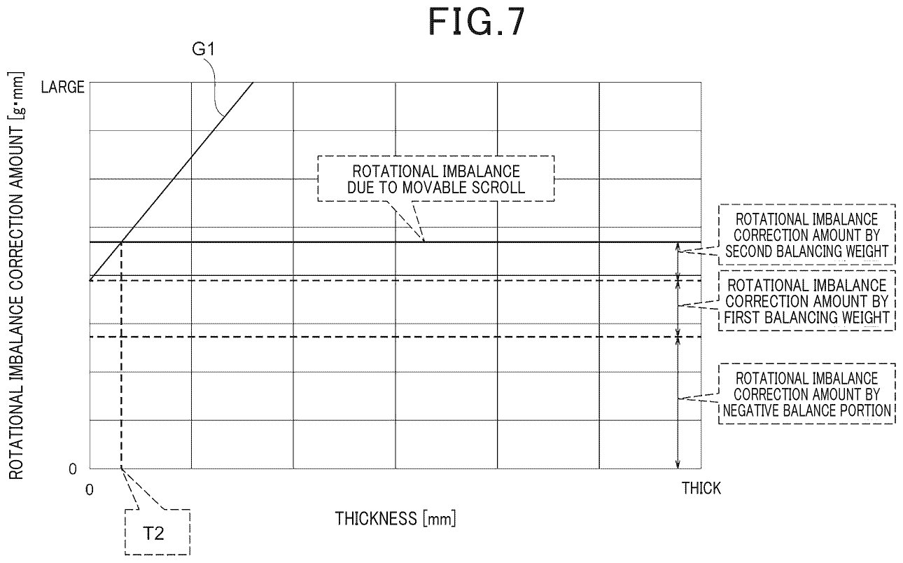

FIG. 7 is a graph showing a relationship between the thickness of the second balancing weight 64 and a rotational imbalance correction amount according to the present embodiment. The rotational imbalance correction amount is an example of the “imbalance correction amount” of the present disclosure. The imbalance correcting portion 80 has, as a rotational imbalance correction amount for correcting the rotational imbalance due to the movable scroll 38, a rotational imbalance correction amount by the first balancing weight 62, a rotational imbalance correction amount by the second balancing weight 64, and a rotational imbalance correction amount by the negative balance portion 78.

The rotational imbalance correction amount by the negative balance portion 78 corresponds to a rotational imbalance correction amount by the second area A2 on the side opposite the first area A1 in which the negative balance portion 78 is formed. The rotational imbalance and the rotational imbalance correction amount referred to herein are calculated by a product of mass and a distance from a rotation axis to a center of gravity along the radial direction of the rotor core 30. Respective positions of the first balancing weight 62, the second balancing weight 64, and the negative balance portion 78 in the circumferential direction of the rotor core 30 are set such that the rotational imbalance correction amount by the first balancing weight 62, the rotational imbalance correction amount by the second balancing weight 64, and the rotational imbalance correction amount by the negative balance portion 78 are balanced with the rotational imbalance due to the movable scroll 38.

In the example shown in FIG. 7, the thickness of the second balancing weight 64 is determined with the rotational imbalance correction amount by the first balancing weight 62 and the rotational imbalance correction amount by the negative balance portion 78 as fixed values. A graph G1 is a graph showing a relationship between the thickness of the second balancing weight 64 and the rotational imbalance correction amount. When the rotational imbalance due to the movable scroll 38 is an establishment condition (target value), the second balancing weight 64 is merely required to have a thickness T2 corresponding to an intersection between the graph G1 and the target value to correct the rotational imbalance due to the movable scroll 38.

Here, the thickness of the second balancing weight 64 is determined. However, dimensions other than thickness may be determined. In addition, the rotational imbalance correction amount by the first balancing weight 62 and the rotational imbalance correction amount by the negative balance portion 78 are fixed values. However, a dimension of the first balancing weight 62 may be determined with the rotational imbalance correction amount by the second balancing weight 64 and the rotational imbalance correction amount by the negative balance portion 78 as the fixed values. Furthermore, a dimension of the negative balance portion 78 may be determined with the rotational imbalance correction amount by the first balancing weight 62 and the rotational imbalance correction amount by the second balancing weight 64 as the fixed values.

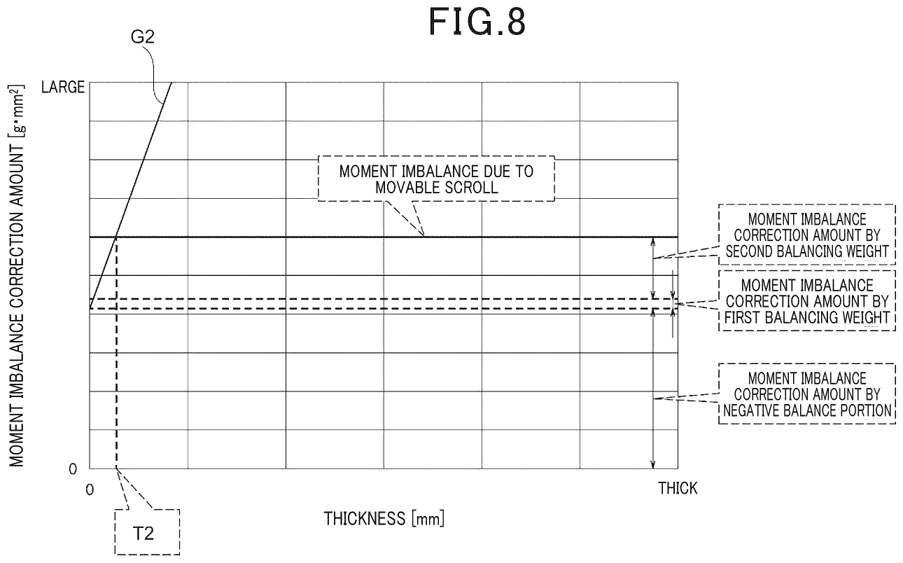

FIG. 8 is a graph showing a relationship between the thickness of the second balancing weight 64 and a moment imbalance correction amount according to the present embodiment. The moment imbalance correction amount is an example of the “imbalance correction amount” of the present disclosure. The imbalance correcting portion 80 has, as a moment imbalance correction amount for correcting the moment imbalance due to the movable scroll 38, a moment imbalance correction amount by the first balancing weight 62, a moment imbalance correction amount by the second balancing weight 64, and a moment imbalance correction amount by the negative balance portion 78.

The moment imbalance correction amount by the negative balance portion 8 corresponds to a moment imbalance correction amount by the second area A2 on the side opposite the first area A1 in which the negative balance portion 78 is formed. The moment imbalance and the moment imbalance correction amount referred to herein are calculated by a product of the rotational imbalance correction amount and a distance from the first bearing 48 to the center of gravity along the axial direction of the rotor core 30. Respective positions of the first balancing weight 62, the second balancing weight 64, and the negative balance portion 78 are set such that the moment imbalance correction amount by the first balancing weight 62, the moment imbalance correction amount by the second balancing weight 64, and the moment imbalance correction amount by the negative balance portion 78 are balanced with the moment imbalance due to the movable scroll 38.

In the example shown in FIG. 8, the thickness of the second balancing weight 64 is determined with the moment imbalance correction amount by the first balancing weight 62 and the moment imbalance correction amount by the negative balance portion 78 as fixed values. A graph G2 is a graph showing a relationship between the thickness of the second balancing weight 64 and the moment imbalance. When the moment imbalance due to the movable scroll 38 is an establishment condition (target value), the second balancing weight 64 is merely required to have the thickness T2 corresponding to an intersection between the graph G2 and the target value to correct the moment imbalance by the movable scroll 38.

Here, the thickness of the second balancing weight 64 is determined. However, dimensions other than thickness may be determined. In addition, the moment imbalance correction amount by the first balancing weight 62 and the moment imbalance correction amount by the negative balance portion 78 are fixed values. However, a dimension of the first balancing weight 62 may be determined with the moment imbalance correction amount by the second balancing weight 64 and the moment imbalance correction amount by the negative balance portion 78 as the fixed values. Furthermore, a dimension of the negative balance portion 78 may be determined with the moment imbalance correction amount due to the first balancing weight 62 and the moment imbalance correction amount due to the second balancing weight 62 as the fixed values.

Next, effects according to the present embodiment will be described.

According to the present embodiment, the rotor core 30 includes the first balancing weight 62 provided on the end surface on one side in the axial direction of the rotor core 30 and the second balancing weight 64 provided on the end surface on the other side in the axial direction of the rotor core 30. Therefore, the imbalance in the rotating body including the rotor 60 can be corrected by both the first balancing weight 62 and the second balancing weight 64. Consequently, for example, compared to a case in which only one of the first balancing weight 62 and the second balancing weight 64 is provided, imbalance in the rotating body can be easily corrected.

In addition, according to the present embodiment, the first balancing weight 62 has the fixing portion 82 fixed to the end surface on one side in the axial direction of the rotor core 30, the axial-direction extending portion 84 extending from the end portion 82A on the outer peripheral side of the fixing portion 82 toward one side in the axial direction of the rotor core 30, and the radial-direction extending portion 86 extending from the end portion 84A on the tip end side of the axial-direction extending portion 84 toward the outer side in the radial direction of the rotor core 30. Therefore, for example, imbalance in the rotating body can be corrected by adjusting the length of the fixing portion 82 along the radial direction of the rotor core 30, the length of the axial-direction extending portion 84 along the axial direction of the rotor core, the length of the radial-direction extending portion along the radial direction of the rotor core 30, and the like. Consequently, imbalance in the rotating body can be easily corrected.

Furthermore, according to the present embodiment, the length L1 of the radial-direction extending portion 86 along the radial direction of the rotor core 30 is longer than the length L2 of the axial-direction extending portion 84 along the axial direction of the rotor core 30. Therefore, for example, compared to a case in which the length L1 of the radial-direction extending portion 86 is shorter than the length L2 of the axial-direction extending portion 84, the imbalance correction amount by the first balancing weight 62 can be increased.

In addition, according to the present embodiment, the thickness T1 of the fixing portion 82 along the axial direction of the rotor core 30 is thinner than the thickness T2 of the second balancing weight 64 along the axial direction of the rotor core 30. Therefore, for example, compared to a case in which the thickness T1 of the fixing portion 82 is equal to the thickness T2 of the second balancing weight 64, the length of the rotor 60 in the axial direction can be suppressed.

Furthermore, according to the present embodiment, the fixing portion 82, the axial-direction extending portion 84, and the radial-direction extending portion 86 are formed into plate shapes. Therefore, the shapes of the fixing portion 82, the axial-direction extending portion 84, and the radial-direction extending portion 86 can be set based on the spaces 96, 98, and 100 surrounding the rotor core 30. Consequently, for example, compared to a case in which the first balancing weight 62 is formed into a block shape, the degree of freedom in arrangement of the first balancing weight 62 can be enhanced.

In addition, according to the present embodiment, the rotor core 30 has the shaft insertion hole 74 formed in the center portion of the rotor core 30 and into which the shaft 22 is inserted. The first balancing weight 62 has the key groove 90 and the positioning hole 92 for positioning to the shaft 22. Therefore, the first balancing weight 62 can be positioned relative to the shaft 22 using the key groove 90 and the positioning hole 92. Consequently, for example, compared to a case in which the key groove 90 and the positioning hole 92 are not provided, accuracy of the imbalance correction amount by the first balancing weight 62 can be ensured.

Furthermore, according to the present embodiment, the rotor core 30 has the negative balance portion 78 formed in a hollow shape in a position eccentric from the center portion of the rotor core 30, toward the outer side in the radial direction of the rotor core 30. Therefore, the imbalance in the rotating body can be corrected by the negative balance portion 78 as well, in addition to the first balancing weight 62 and the second balancing weight 64. Consequently, for example, compared to a case in which the rotor core 30 does not have the negative balance portion 78, the first balancing weight 62 and the second balancing weight 64 can be reduced in size.

In addition, according to the present embodiment, the negative balance portion 78 is formed in a position avoiding the magnetic path generated by the rotor magnet 32. Therefore, for example, compared to a case in which at least a portion of the negative balance portion 78 is formed in the magnetic path generated by the rotor magnet 32, the area for the magnetic path can be secured. Consequently, deterioration of characteristics of the motor unit 12 can be suppressed.

Furthermore, according to the present embodiment, the radial-direction extending portion 86 is disposed in the space 100 between the stator 18 and the compressor housing 34 in the axial direction of the motor unit 12. The space 100 is dead space. Therefore, increase in size of the compressor 10 in the axial direction can be suppressed even when the balancing weight is provided.

In addition, according to the present embodiment, the rotor 60 includes the imbalance correcting portion 80 including the first balancing weight 62, the second balancing weight 64, and the negative balance portion 78. The imbalance correcting portion 80 has the imbalance correction amount that corrects the imbalance due to the movable scroll 38. Therefore, the imbalance in the rotating body including the rotor 60 and the movable scroll 38 can be corrected. Consequently, occurrence of noise and the like accompanying the rotation of the rotating body can be suppressed.

Furthermore, according to the present embodiment, the connecting portion between the axial-direction extending portion 84 and the fixing portion 82 (that is, the end portion 82A on the outer peripheral side of the fixing portion 82) is positioned further toward the inner side than the external form of the rotor core 30 is. Therefore, the fixing portion 82 interfering with the stator core 24 disposed on the outer side in the radial direction of the rotor core 30 can be suppressed. In addition, the end portion 86A on the outer peripheral side of the radial-direction extending portion 86 is positioned further toward the inner side than the external form of the stator core 24 is. Therefore, the radial-direction extending portion 86 interfering with the motor housing 16 and the like disposed on the outer side in the radial direction of the stator core 24 can be suppressed.

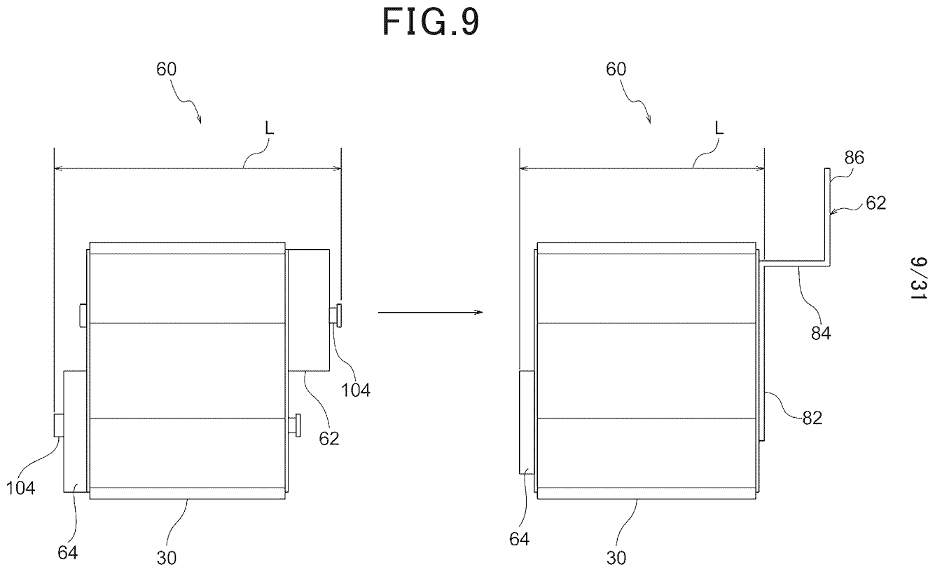

FIG. 9 is a diagram comparing axial lengths of two types of rotors 60. In the rotor 60 shown on a left-hand side in FIG. 9, the first balancing weight 62 and the second balancing weight 64 are each formed into a block shape. In addition, the first balancing weight 62 and the second balancing weight 64 are each fixed to the rotor core 30 by a rivet 104. The rotor 60 shown on a right-hand side in FIG. 9 is the rotor shown in FIG. 1 to FIG. 8. As a result of the rotor 60 shown on the right-hand side in FIG. 9, an axial length L can be made short compared to the rotor 60 shown on the left-hand side in FIG. 9.

Next, modifications according to the present embodiment will be described.

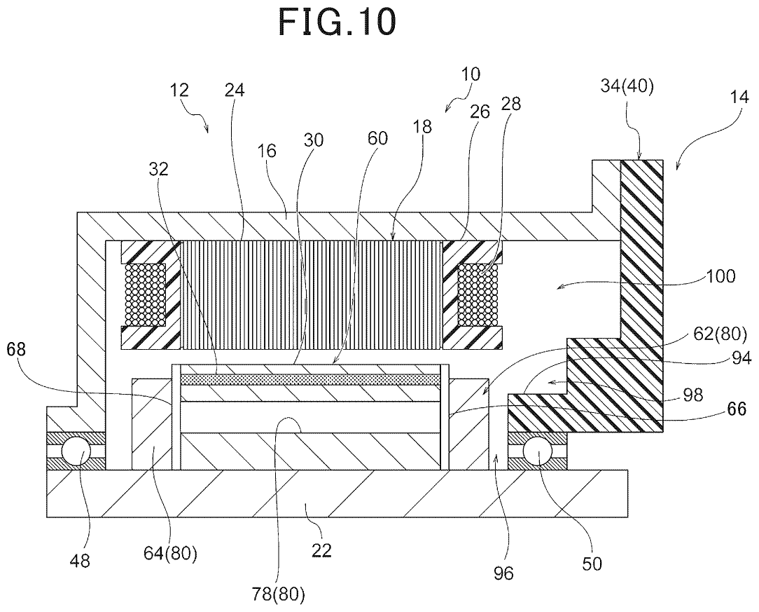

FIG. 10 is a longitudinal cross-sectional view of a first modification of a combination of the first balancing weight 62 and the second balancing weight 64. In the first modification shown in FIG. 10, the first balancing weight 62 is formed into a block shape. The first balancing weight 62 may have the same shape as the second balancing weight 64 or a differing shape.

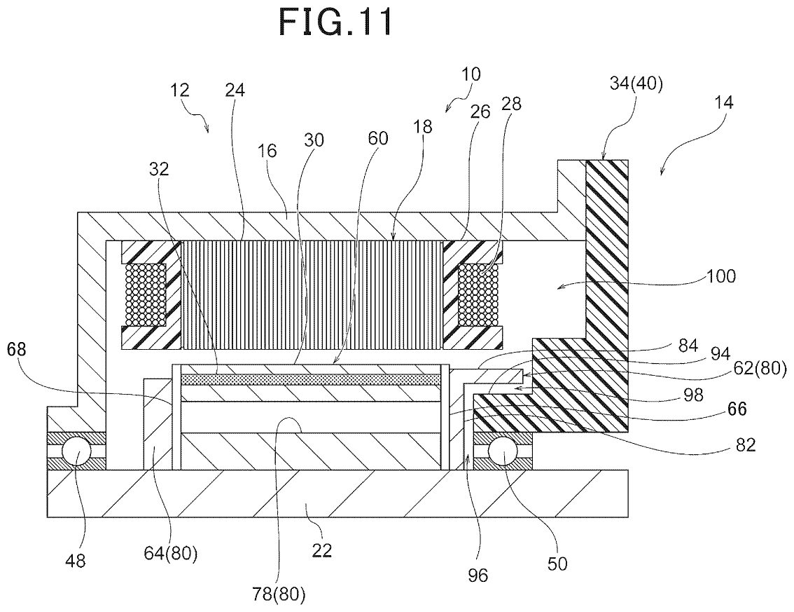

FIG. 11 is a longitudinal cross-sectional view of a second modification of the combination of the first balancing weight 62 and the second balancing weight 64. In the second modification shown in FIG. 11, the configuration is such that a section from the first balancing weight 62 to the radial-direction extending portion 86 is omitted, and the first balancing weight 62 has the fixing portion 82 and the axial-direction extending portion 84.

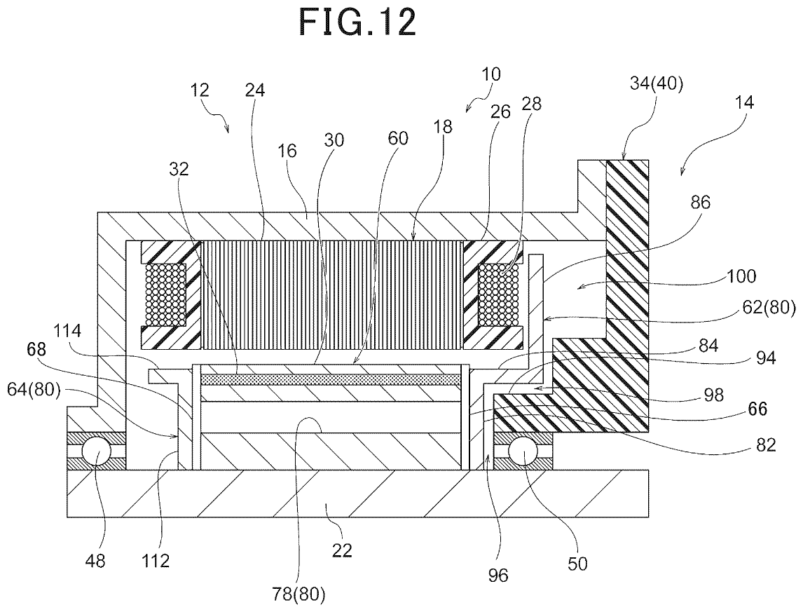

FIG. 12 is a longitudinal cross-sectional view of a third modification of the combination of the first balancing weight 62 and the second balancing weight 64. In the third modification shown in FIG. 12, the configuration is such that the second balancing weight 64 has a fixing portion 112 and an axial-direction extending portion 114. The fixing portion 112 is an example of the “second fixing portion” of the present disclosure. The axial-direction extending portion 114 is an example of the “second axial-direction extending portion” of the present disclosure. The fixing portion 112 is fixed to the end surface on the other side in the axial direction of the rotor core 30 with the second cover plate 68 therebetween. The axial-direction extending portion 114 extends from an end portion on an outer peripheral side of the fixing portion 112 toward the outer side in the axial direction of the rotor core 30.

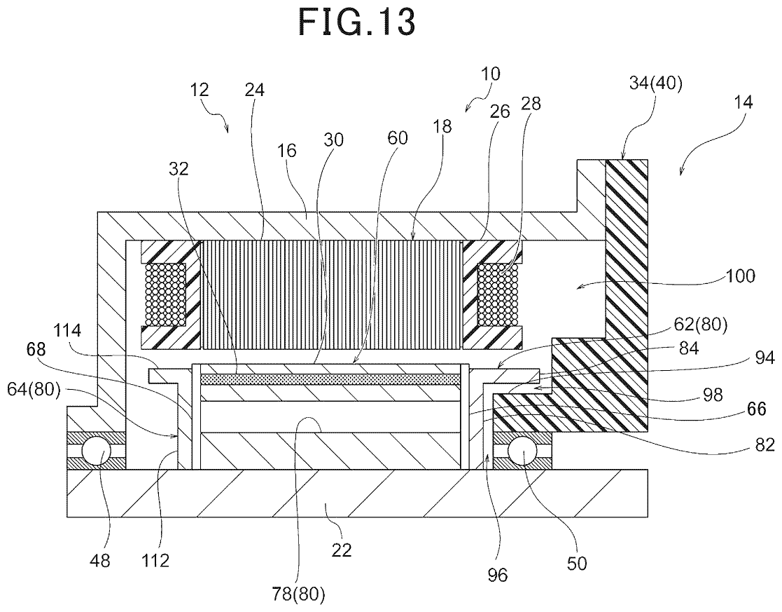

FIG. 13 is a longitudinal cross-sectional view of a fourth modification of the combination of the first balancing weight 62 and the second balancing weight 64. In the fourth modification shown in FIG. 13, the configuration is such that the first balancing weight 62 has the fixing portion 82 and the axial-direction extending portion 84. The configuration is also such that the second balancing weight 64 also has the fixing portion 112 and the axial-direction extending portion 114 in a manner similar to the first balancing weight 62.

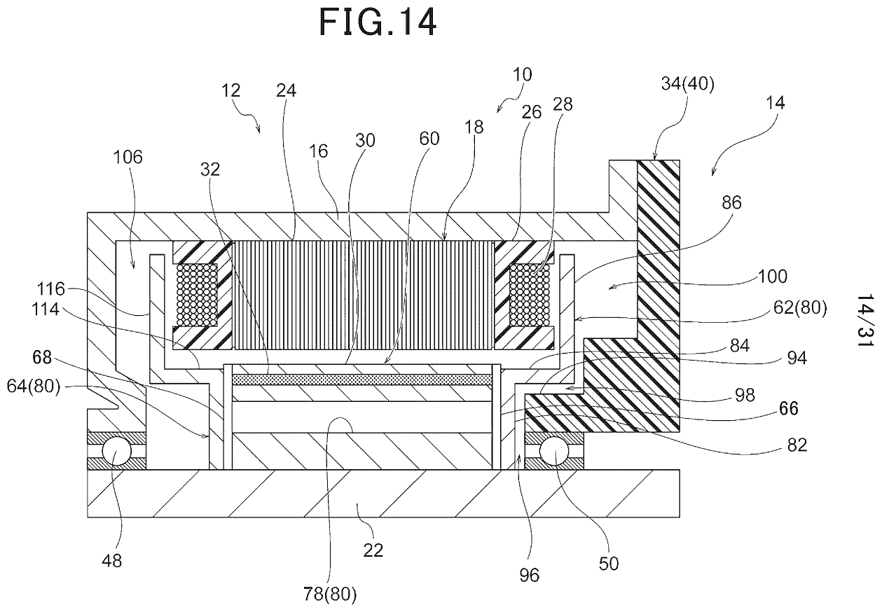

FIG. 14 is a longitudinal cross-sectional view of a fifth modification of the combination of the first balancing weight 62 and the second balancing weight 64. In the fifth modification shown in FIG. 14, the second balancing weight 64 has a radial-direction extending portion 116. The radial-direction extending portion 116 is an example of the “second radial-direction extending portion” of the present disclosure. The radial-direction extending portion 116 extends from the end portion on the tip end side of the axial-direction extending portion 84 toward the outer side in the radial direction of the rotor core 30. The radial-direction extending portion 116 is disposed in a space 106 between the stator 18 and a bottom portion of the motor housing 16. The space 106 is a dead space formed between the stator 18 and the compressor housing 34 in the axial direction of the motor unit 12.

As a result of a configuration such as this, for example, the imbalance in the rotating body can be corrected by adjusting the length of the fixing portion 112 along the radial direction of the rotor core 30, the length of the axial-direction extending portion 114 along the axial direction of the rotor core 30, the length of the radial-direction extending portion 116 along the radial direction of the rotor core 30, and the like. Consequently, the imbalance in the rotating body can be easily corrected.

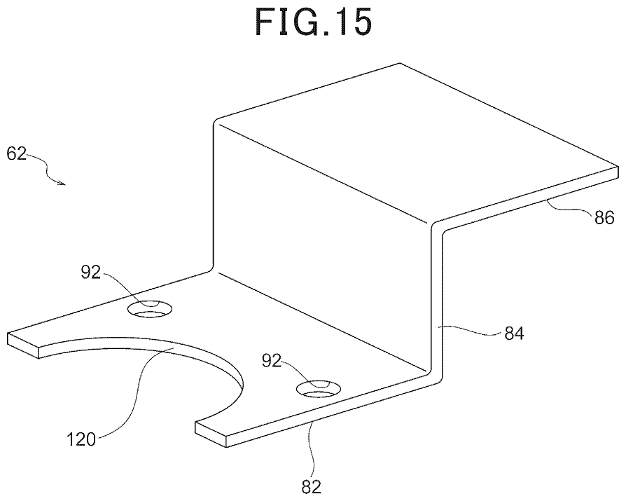

FIG. 15 is a perspective view of a first modification of the shape of the first balancing weight 62. In the first modification shown in FIG. 15, instead of the shaft insertion hole 88, a notch 120 into which the shaft 22 is inserted is formed in a semicircular shape. The first balancing weight 62 may be fixed to the rotor core 30 by a rivet (not shown) being inserted into the positioning hole 92 and press-fitted into a rivet hole formed in the rotor core 30.

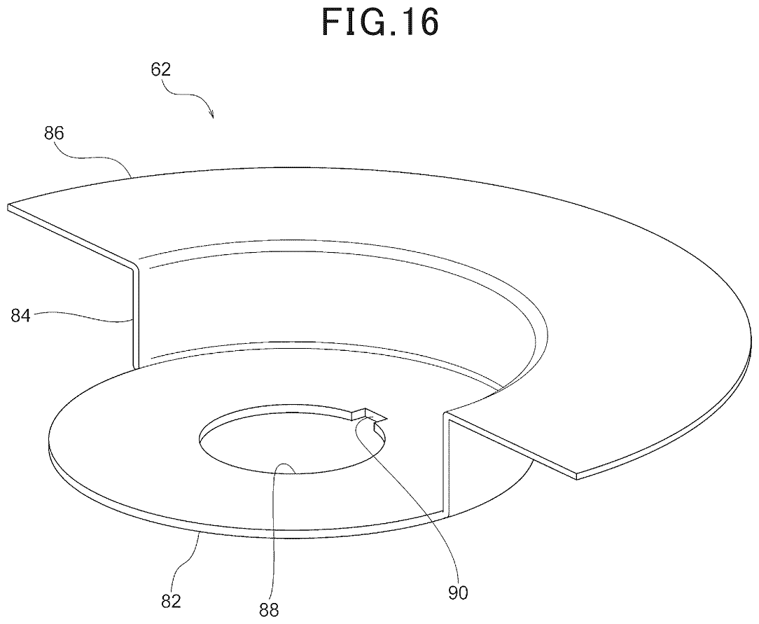

FIG. 16 is a perspective view of a second modification of the shape of the first balancing weight 62. In the second modification shown in FIG. 16, the fixing portion 82 is formed into a circular shape. In addition, the axial-direction extending portion 84 and the radial-direction extending portion 86 are each formed into a circular arc shape along the circumferential direction of the rotor core 30 As a result of a configuration such as this, for example, compared to a case in which the axial-direction extending portion 84 and the radial-direction extending portion 86 are formed into rectangular shapes, the sizes of the axial-direction extending portion 84 and the radial-direction extending portion 86 can be increased. Consequently, the imbalance correction amount by the first balancing weight 62 can be increased. Here, notches may be formed in appropriate locations in the radial-direction extending portion 86 to form the radial-direction extending portion 86 by cut-and-raised tabs.

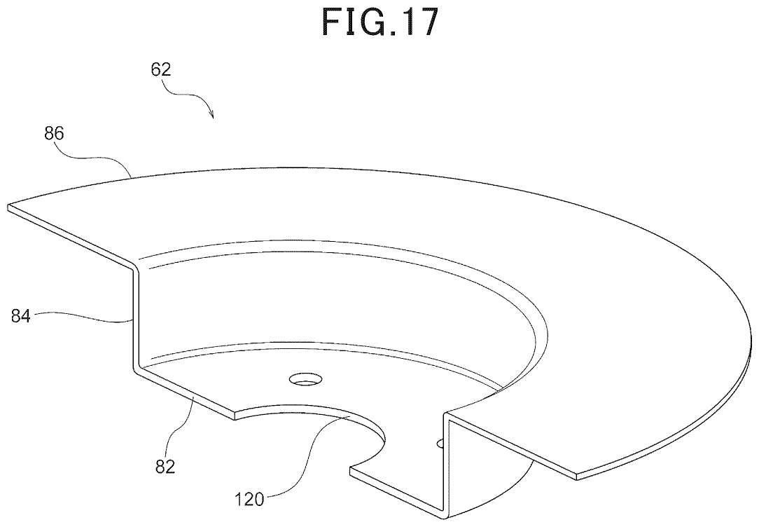

FIG. 17 is a perspective view of a third modification of the shape of the first balancing weight 62. In the third modification shown in FIG. 17, the fixing portion 82 is formed into a semicircular shape in the second modification shown in FIG. 16. In addition, instead of the shaft insertion hole 88, the notch 120 into which the shaft 22 is inserted is formed in a semicircular shape in the fixing portion 82.

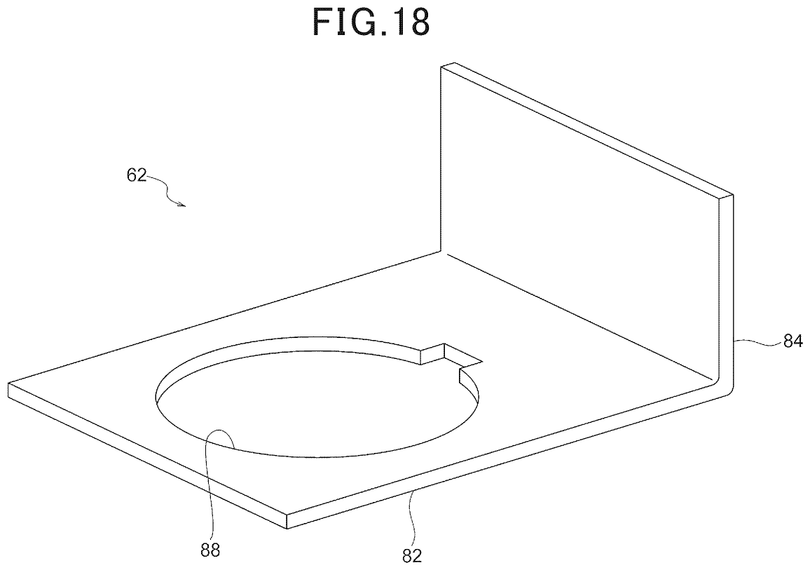

FIG. 18 is a perspective view of a fourth modification of the shape of the first balancing weight 62. In the fourth modification shown in FIG. 18, the configuration is such that a section from the first balancing weight 62 to the radial-direction extending portion 86 is omitted, and the first balancing weight 62 includes the fixing portion 82 and the axial-direction extending portion 84.

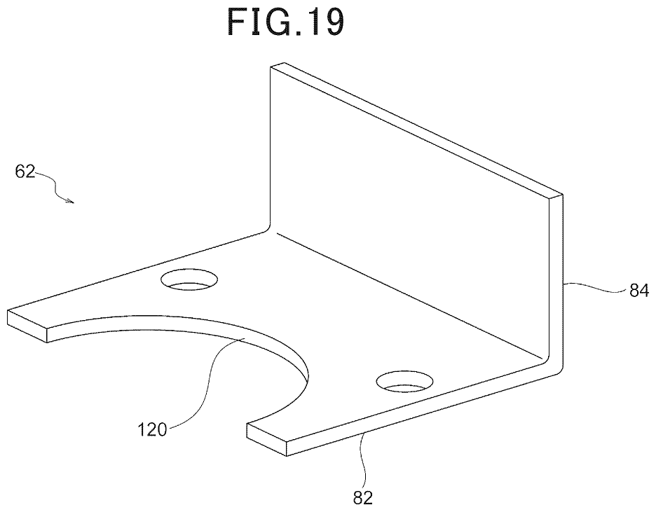

FIG. 19 is a perspective view of a fifth modification of the shape of the first balancing weight 62. In the fifth modification shown in FIG. 19, instead of the shaft insertion hole 88, the notch 120 into which the shaft 22 is inserted is formed in a semicircular shape in the fixing portion 82 in the fourth modification shown in FIG. 18.

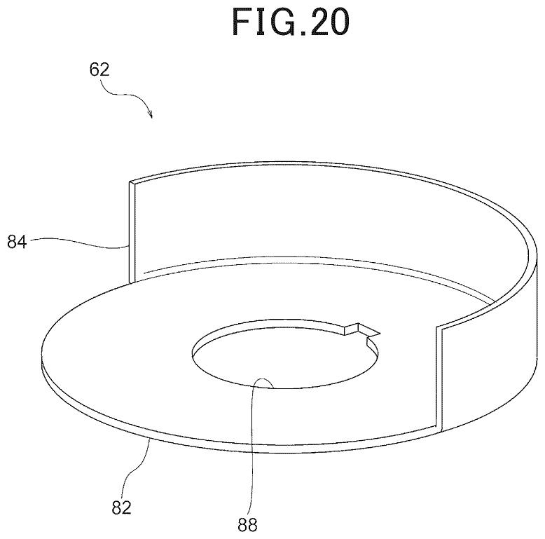

FIG. 20 is a perspective view of a sixth modification of the shape of the first balancing weight 62. In the sixth modification shown in FIG. 20, the configuration is such that a section from the first balancing weight 62 to the radial-direction extending portion 86 is omitted, and the first balancing weight 62 includes the fixing portion 82 and the axial-direction extending portion 84 in the second modification shown in FIG. 16. Here, notches may be formed in appropriate locations in the axial-direction extending portion 84 to form the axial-direction extending portion 84 by cut-and-raised tabs.

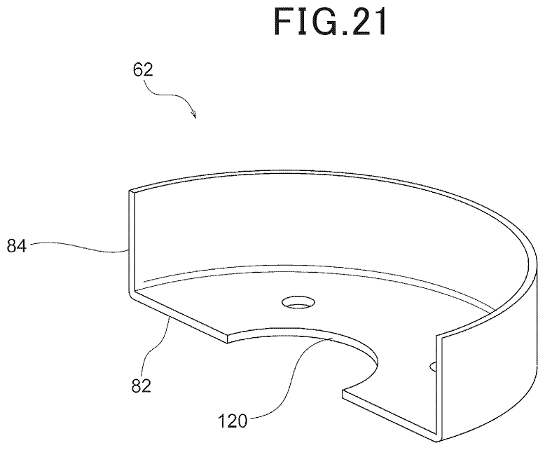

FIG. 21 is a perspective view of a seventh modification of the shape of the first balancing weight 62. In the seventh modification shown in FIG. 21, the fixing portion 82 is formed in a semicircular shape in the sixth modification shown in FIG. 20. In addition, instead of the shaft insertion hole 88, the notch 120 into which the shaft 22 is inserted is formed in a semicircular shape in the fixing portion 82.

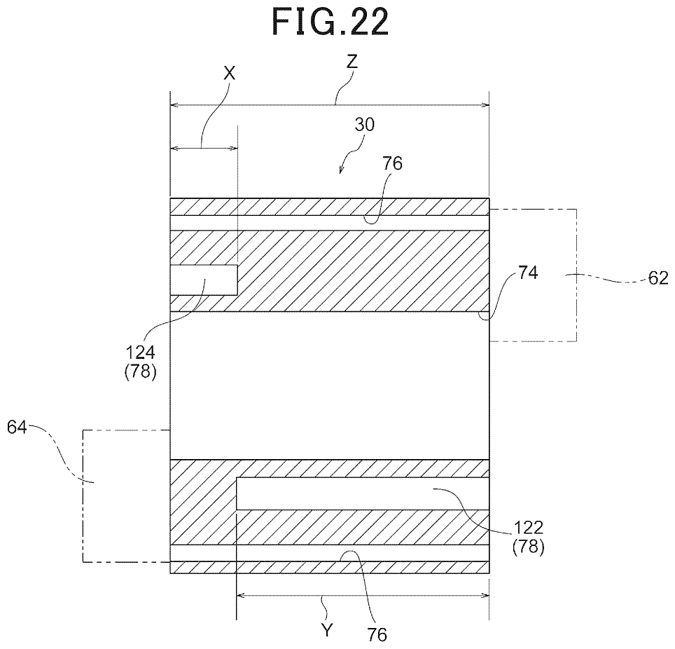

FIG. 22 is a longitudinal cross-sectional view of a modification of the configuration of the negative balance portion 78. In the modification shown in FIG. 22, the negative balance portion 78 has a first negative balance portion 122 open on the end surface on one side in the axial direction of the rotor core 30 and a second negative balance portion 124 open on the end surface on the other side in the axial direction of the rotor core 30.

The first negative balance portion 122 and the second negative balance portion 124 terminate in a same position in the axial direction of the rotor core 24. A depth Y of the second negative balance portion 124 is set to a value obtained by subtracting a depth X of the first negative balance portion 122 from an axial length Z of the rotor core 30. Here, the first negative balance portion 122 and the second negative balance portion 124 may terminate in differing positions in the axial direction of the rotor core 30. In addition, the first negative balance portion 122 and the second negative balance portion 124 may each pass through in the axial direction of the rotor core 30.

As a result of a configuration such as this, the imbalance in the rotating body can be corrected by both the first negative balance portion 122 and the second negative balance portion 124. Consequently, for example, compared to a case in which the negative balance portion 78 includes only either of the first negative balance portion 122 and the second negative balance portion 124, the imbalance in the rotating body can be easily corrected.

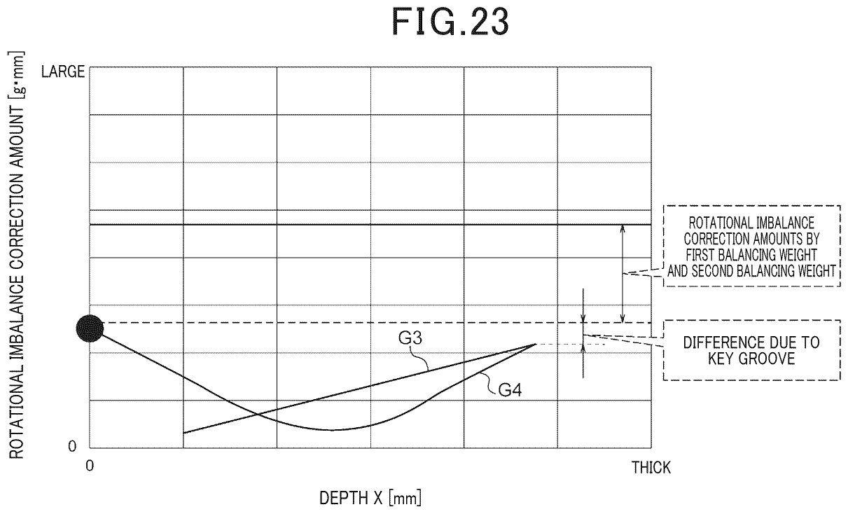

FIG. 23 is a graph showing a relationship between the depth X of the first negative balance portion 122 and the rotational imbalance correction amount. In an example shown in FIG. 23, the depth X of the first negative balance portion 122 is determined with the rotational imbalance correction amounts by the first balancing weight 62 and the second balancing weight 64 as fixed values. Graph G3 and graph G4 are graphs showing the relationships between the depth X of the first negative balance portion 122 and the rotational imbalance correction amount of the negative balance portion 78. The rotor 30 is configured by a plurality of core sheets being laminated. Graph G3 shows a case in which the core sheets in which the first negative balance portion 122 is formed are not rotated and stacked. Graph G4 shows a case in which the core sheets in which the first negative balance portion 122 is formed are rotated and stacked.

Here, a difference between the rotational imbalance correction amounts by the first balancing weight 62 and the second balancing weight 64, and the rotational imbalance correction amount by the negative balance portion 78 occur on one side in the axial direction of the rotor core 30 due to an effect the key groove 90.

As shown in graph G3, when the core sheets are not rotated and stacked, the depth X of the first negative balance portion 122 and the rotational imbalance correction amount by the negative balance portion 78 are proportional. Meanwhile, as shown in graph G4, when the core sheets are rotated and stacked, the rotational imbalance correction amount by the negative balance portion 78 changes such as to have a local minimum value, as the depth X of the first negative balance portion 122 increases. In this manner, the rotational imbalance correction amount by the negative balance portion 78 can be adjusted by rotating and stacking the core sheets.

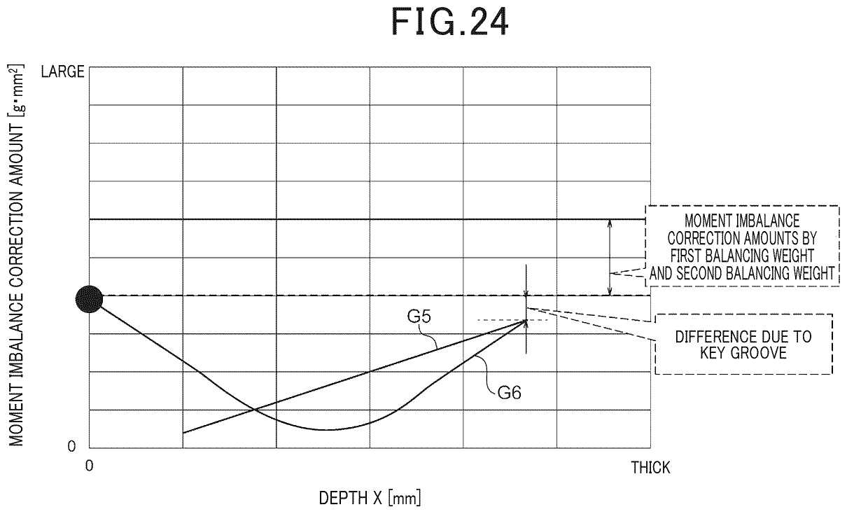

FIG. 24 is a graph showing a relationship between the depth X of the first negative balance portion 122 and the moment imbalance correction amount. In an example shown in FIG. 24, the depth X of the first negative balance portion 122 is determined with the moment imbalance correction amounts by the first balancing weight 62 and the second balancing weight 64 as fixed values. A graph G5 and a graph G6 are graphs showing a relationship between the depth X of the first negative balance portion 122 and the moment imbalance correction amount by the negative balance portion 78. Graph G5 shows a case in which the core sheets in which the first negative balance portion 122 is formed are not rotated and stacked. Graph G6 shows a case in which the core sheets in which the first negative balance portion 122 is formed are rotated and stacked.

Here, a difference between the moment imbalance correction amounts by the first balancing weight 62 and the second balancing weight 64, and the moment imbalance correction amount by the negative balance portion 78 occur on one side in the axial direction of the rotor core 30 due to an effect of the key groove 90.

As shown in graph G5, when the core sheets are not rotated and stacked, the depth X of the first negative balance portion 122 and the moment imbalance correction amount by the negative balance portion 78 are proportional. Meanwhile, as shown in graph G6, when the core sheets are rotated and stacked, the moment imbalance correction amount by the negative balance portion 78 changes such as to have a local minimum value, as the depth X of the first negative balance portion 122 increases. In this manner, the moment imbalance correction amount by the negative balance portion 78 can be adjusted by rotating and stacking the core sheets.

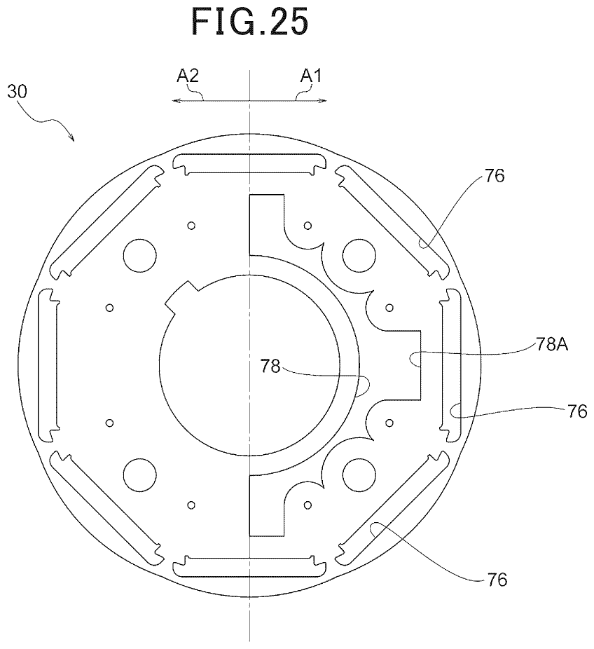

FIG. 25 is a a diagram of a rotor core showing a first modification of the shape of the negative balance portion 78, viewed from one side in the axial direction. In the modification shown in FIG. 25, a portion 78A of the negative balance portion 78 is formed in a position corresponding to a center portion in a lateral width direction of the rotor magnet 32 (or in other words, the magnet housing hole 76). The lateral width direction of the rotor magnet 32 is a direction along a tangential direction of the rotor core 30. The portion 78A of the negative balance portion 78 is formed into a recessing shape. The portion 78A of the negative balance portion 78 is formed in a position avoiding the magnetic path generated by the rotor magnet 32.

As a result of a configuration such as this, the portion 78A of the negative balance portion 78 can be positioned further toward the outer side in the radial direction of the rotor core 30 while preventing the portion 78A of the negative balance portion 78 from being formed in the magnetic path generated by the rotor magnet 32.

Here, the overall negative balance portion 78 may be formed in the position corresponding to the center portion in the lateral width direction of the rotor magnet 32.

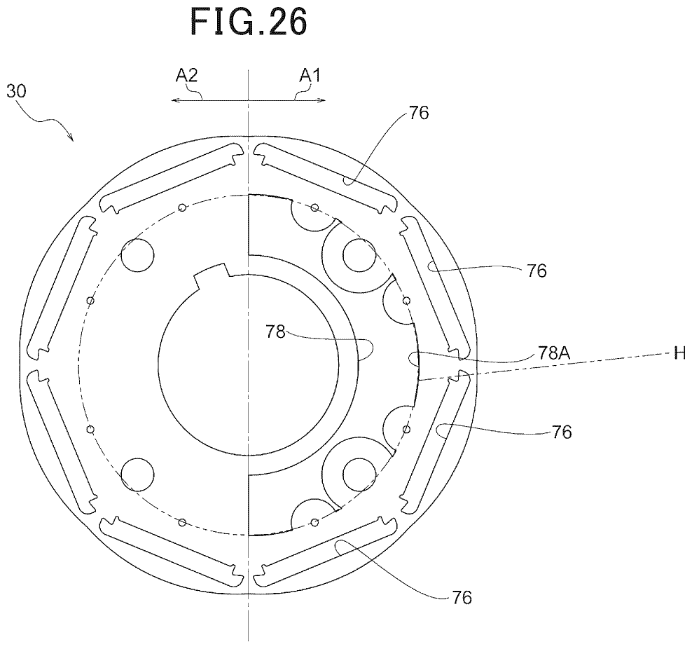

FIG. 26 is a diagram of a rotor core showing a second modification of the shape of the negative balance portion 78, viewed from one side in the axial direction. In the modification shown in FIG. 26, the portion 78A of the negative balance portion 78 is formed in a position corresponding to a portion between adjacent rotor magnets 32 (in other words, adjacent magnet housing holes 76). The portion 78A of the negative balance portion 78 is formed into a recessing shape. The portion 78A is formed in a position avoiding the magnetic path generated by the rotor magnet 32. A virtual line H is an outermost diameter line of the position avoiding the magnetic path generated by the rotor magnet 32. The negative balance portion 78 is formed further toward the inner side in the radial direction of the rotor core 30 than the virtual line H is.

As a result of a configuration such as this, the portion 78A of the negative balance portion 78 can be positioned further toward the outer side in the radial direction of the rotor core 30 while preventing the portion 78A of the negative balance portion 78 from being formed in the magnetic path generated by the rotor magnet 32.

Here, the overall negative balance portion 78 may be formed in the position corresponding to the portion between adjacent rotor magnets 32.

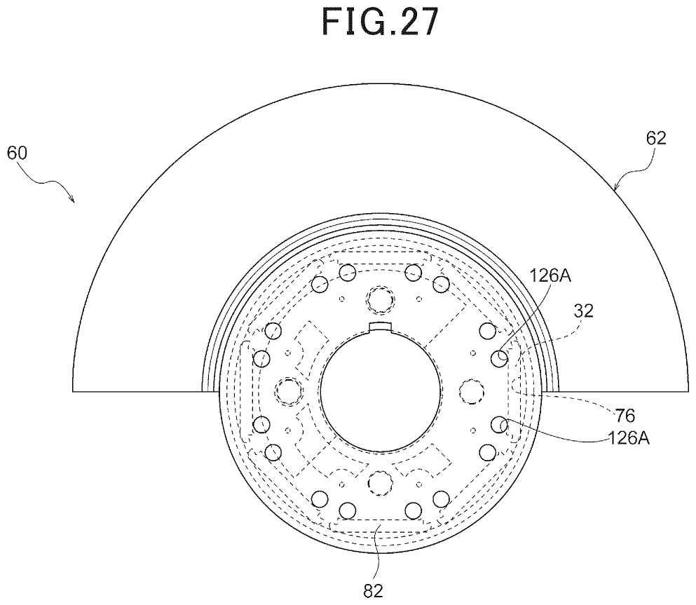

FIG. 27 is a first modification of the fixing portion 82 of the first balancing weight 62. In the first modification shown in FIG. 27, the fixing portion 82 disposed in a position sealing the magnet housing hole 76 has a magnet cooling hole 126A. The magnet cooling hole 126A is formed in a position adjacent to the rotor magnet 32 when viewed from the axial direction of the rotor core 30 and passes through in a plate-thickness direction of the fixing portion 82. As an example, the magnet cooling hole 126A is formed in a position adjacent to an end portion in the lateral width direction of the rotor magnet 32. Here, although not shown, a magnet cooling hole communicating with the magnet cooling hole 126A may also be formed in the first cover plate 66 (see FIG. 1 and the like) disposed between the fixing portion 82 and the rotor core 30. As a result of a configuration such as this, the rotor magnet 32 can be cooled by sending a fluid to the magnet cooling hole 126A.

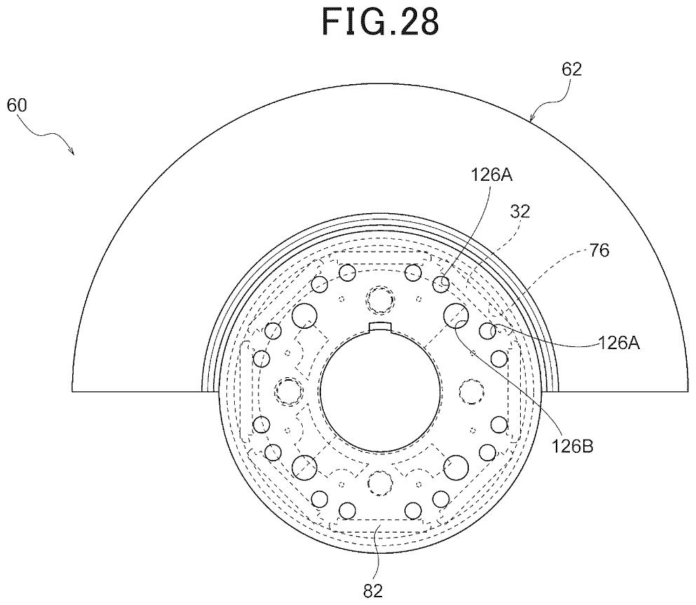

FIG. 28 is a longitudinal cross-sectional view of a second modification of the fixing portion 82 of the first balancing weight 62. In the second modification shown in FIG. 28, the fixing portion 82 disposed in a position sealing the magnet housing hole 76 has a magnet cooling hole 126B in addition to the magnet cooling hole 126A. The magnet cooling hole 126B is formed in a position adjacent to the rotor magnet 32 when viewed from the axial direction of the rotor core 30 and passes through in the plate-thickness direction of the fixing portion 82. As an example, the magnet cooling hole 126B is formed in a position adjacent to the center portion in the lateral width direction of the rotor magnet 32. Here, although not shown, a magnet cooling hole communicating with the magnet cooling hole 126B may also be formed in the first cover plate 66 (see FIG. 1 and the like) disposed between the fixing portion 82 and the rotor core 30. As a result of a configuration such as this, the rotor magnet 32 can be cooled by sending a fluid to the magnet cooling hole 126B.

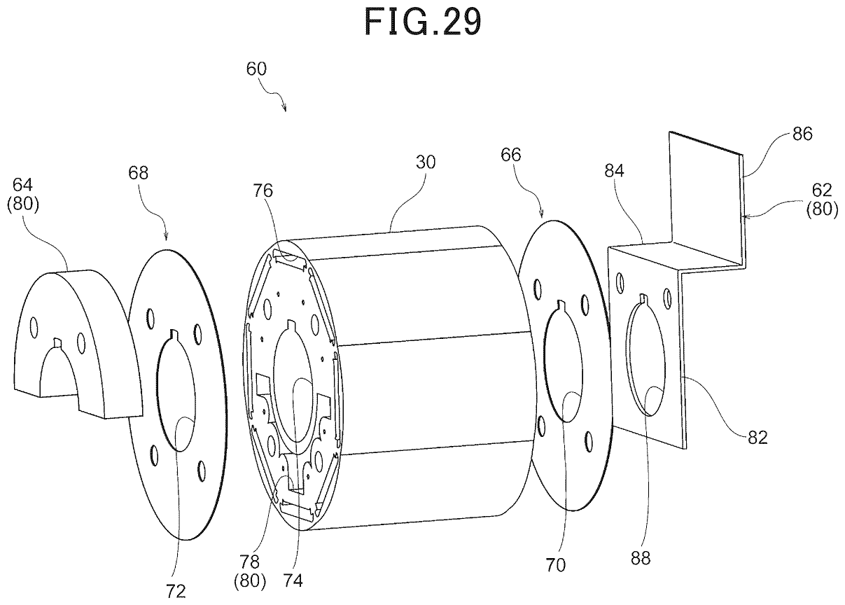

FIG. 29 is an exploded perspective view of a first modification of the configuration of the rotor 60. In the first modification shown in FIG. 29, the second balancing weight 64 is disposed on a same side as the axial-direction extending portion 84 and the radial-direction extending portion 86 of the first balancing weight 62. The negative balance portion 78 is formed on a side opposite the axial-direction extending portion 84 and the radial-direction extending portion 86 of the first balancing weight 62.

The example shown in FIG. 29 is an example. The respective positions of the first balancing weight 62, the second balancing weight 64, and the negative balance portion 78 in the circumferential direction of the rotor core 30 are set such that the imbalance correction amount by the first balancing weight 62, the imbalance correction amount by the second balancing weight 64, and the imbalance correction amount by the negative balance portion 78 are balanced with the imbalance due to the movable scroll 38.

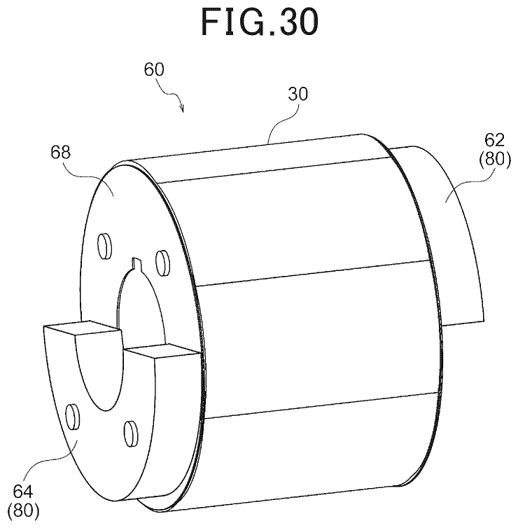

FIG. 30 is a perspective view of a second modification of the configuration of the rotor 60. In the second modification shown in FIG. 30, the first balancing weight 62 is formed into a block shape. The first balancing weight 62 may have the same shape as the second balancing weight 64 or a differing shape. As an example, the first balancing weight 62 is disposed on a side opposite the second balancing weight 64. In the example shown in FIG. 30, the negative balance portion 78 may be disposed on the same side as the first balancing weight 62 or the same side as the second balancing weight 64.

Here, according to the above-described embodiment, the rotor 60 has the first balancing weight 62, the second balancing weight 64, and the negative balance portion 78. However, any one or two of the first balancing weight 62, the second balancing weight 64, and the negative balance portion 78 may be omitted.

In addition, according to the above-described embodiment, the rotor 60 having the first balancing weight 62, the second balancing weight 64, and the negative balance portion 78 is applied to the compressor 10 but may be applied to apparatuses other than the compressor 10 as well.

Furthermore, among the plurality of modifications described above, modifications that can be combined may be combined as appropriate.

The present embodiment is described above. However, the present disclosure is not limited to that described above and can, of course, be modified in various ways in addition to that described above without departing from the spirit of the present disclosure.

The present embodiment is supplemented as follows:

### [Supplementary Note 1]

A rotor (60) including: a rotor core (30); a first balancing weight (62) provided on an end surface on one side in an axial direction of the rotor core; and a second balancing weight (64) provided on an end surface on another side in the axial direction of the rotor core.

### [Supplementary Note 2]

The rotor according to the supplementary note 1, in which: the first balancing weight includes a first fixing portion (82) fixed to the end surface on one side in the axial direction of the rotor core and a first axial-direction extending portion (84) extending from an end portion on an outer peripheral side of the first fixing portion toward one side in the axial direction of the rotor core.

### [Supplementary Note 3]

The rotor according to the supplementary note 2, in which: the first balancing weight has a first radial-direction extending portion (86) extending from an end portion on a tip end side of the first axial-direction extending portion toward an outer side in a radial direction of the rotor core.

### [Supplementary Note 4]

The rotor according to the supplementary note 3, in which: a length of the first radial-direction extending portion along the radial direction of the rotor core is longer than a length of the first axial-direction extending portion along the axial direction of the rotor core.

### [Supplementary Note 5]

The rotor according to any one of the supplementary notes 2 to 4, in which: a thickness of the first fixing portion along the axial direction of the rotor core is thinner than a thickness of the second balancing weight along the axial direction of the rotor core.

### [Supplementary Note 6]

The rotor according to any one of the supplementary notes 2 to 5, in which: the first fixing portion and the first axial-direction extending portion are formed into plate shapes.

### [Supplementary Note 7]

The rotor according to any one of the supplementary notes 3, 4, and the supplementary note 5 or 6 dependent on the supplementary note 3, in which: the first fixing portion, the first axial-direction extending portion, and the first radial-direction extending portion are formed into plate shapes.

### [Supplementary Note 8]

The rotor according to any one of the supplementary notes 2 to 7, in which: the first axial-direction extending portion is formed into a circular arc shape along a circumferential direction of the rotor core.

### [Supplementary Note 9]

The rotor according to any one of the supplementary notes 3, 4, and the supplementary notes 5 to 7 dependent on the supplementary note 3, in which: the first axial-direction extending portion and the first radial-direction extending portion are each formed into a circular arc shape along the circumferential direction of the rotor core.

### [Supplementary Note 10]

The rotor according to any one of the supplementary notes 1 to 9, in which: the rotor core has a shaft insertion hole (74) formed in a center portion of the rotor core and into which a shaft is inserted; and the first balancing weight has a positioning portion (90, 92) that positions the first balancing weight relative to the shaft.

### [Supplementary Note 11]

The rotor according to any one of the supplementary notes 1 to 10, in which: the rotor core has a negative balance portion (78) formed into a hollow shape in a position eccentric from a center portion of the rotor core, toward an outer side in a radial direction of the rotor core.

### [Supplementary Note 12]

The rotor according to the supplementary note 11, in which: the rotor includes a rotor magnet (32) provided in a position further toward the outer side in the radial direction of the rotor core than the negative balance portion is; and the negative balance portion is formed in a position avoiding a magnetic path generated by the rotor magnet.

### [Supplementary Note 13]

The rotor according to the supplementary note 11 or 12, in which: the rotor includes a rotor magnet provided in a position further toward the outer side in the radial direction of the rotor core than the negative balance portion is; and at least a portion of the negative balance portion is formed in a position corresponding to a center portion of the rotor magnet in a lateral width direction.

### [Supplementary Note 14]

The rotor according to any one of the supplementary notes 11 to 13, in which: the rotor has a plurality of rotor magnets provided in positions further toward the outer side in the radial direction of the rotor core than the negative balance portion is; the plurality of rotor magnets are arranged to be aligned in a circumferential direction of the rotor; and at least a portion of the negative balance portion is formed in a position corresponding to a portion between adjacent rotor magnets.

### [Supplementary Note 15]

The rotor according to any one of the supplementary notes 11 to 14, in which: the negative balance portion includes a first negative balance portion open on an end surface on one side in the axial direction of the rotor core, and a second negative balance portion open on an end surface on the other side in the axial direction of the rotor core.

### [Supplementary Note 16]

The rotor according to any one of the supplementary notes 3 to 15 dependent on the supplementary notes 2, in which: the rotor core has a magnet housing hole open on an end surface on one side in the axial direction of the rotor core and housing a rotor magnet; the magnet housing hole is sealed by the first fixing portion; and the first fixing portion has a magnet cooling hole (126A, 126B) formed in a position adjacent to the rotor magnet when viewed from the axial direction of the rotor core.

### [Supplementary Note 17]

The rotor according to any one of the supplementary notes 1 to 16, in which: the second balancing weight includes a second fixing portion (112) fixed to an end surface on the other side in the axial direction of the rotor core; a second axial-direction extending portion (114) extending from an end portion on an outer peripheral side of the second fixing portion toward the other side in the axial direction of the rotor core; and a second radial-direction extending portion (116) extending from an end portion on a tip end side of the second axial-direction extending portion toward an outer side in a radial direction of the rotor core.

### [Supplementary Note 18]

A compressor including: a motor unit (12) and a compressor unit (14) provided on one side in an axial direction of the motor unit, in which: the motor unit includes a motor housing (16), a stator (18) fixed to an inner side of the motor housing, a rotor (60) rotatably provided on an inner side of the stator, and a shaft (22) provided in a center portion of the rotor; the compressor unit includes a compressor housing (34) assembled to the motor housing, a fixed scroll (36) fixed on an inner side of the compressor housing, and a movable scroll (38) fixed to the shaft in an eccentric state and turnably provided relative to the fixed scroll; the rotor includes a rotor core (30) and a balancing weight (62) provided on an end surface on one side in an axial direction of the rotor core; the balancing weight includes a fixing portion (82) fixed to an end surface on one side in the axial direction of the rotor core, an axial-direction extending portion (84) extending from an end portion on one side in an axial direction of the fixing portion toward one side in the axial direction of the rotor core, and a radial-direction extending portion (86) extending from an end portion on a tip end side of the axial-direction extending portion toward an outer side in a radial direction of the rotor core; and the radial-direction extending portion is disposed in a space (100) between the stator and the compressor housing in an axial direction of the motor unit.

### [Supplementary Note 19]

The compressor according to the supplementary note 18, in which: the rotor includes an imbalance correcting portion (80) including the balancing weight; and the imbalance correcting portion has an imbalance correction amount countering imbalance due to the movable scroll.

### [Supplementary Note 20]

The compressor according to the supplementary note 18 or 19, in which: the stator includes a stator core (24) disposed on the outer side in the radial direction of the rotor core; a connecting portion between the axial-direction extending portion and the first fixing portion is positioned further toward an inner side than an external form of the rotor core is; and an end portion on an outer peripheral side of the radial-direction extending portion is positioned further toward an inner side than an external form of the stator core is.

What is claimed is:

1. A rotor comprising:
a rotor core;
a first balancing weight provided on an end surface on one side in an axial direction of the rotor core; and
a second balancing weight provided on an end surface on another side in the axial direction of the rotor core, wherein:
the rotor core includes a negative balance portion formed into a hollow shape in a position eccentric from a center portion of the rotor core, toward an outer side in a radial direction of the rotor core;
the rotor includes a rotor magnet provided in a position further toward the outer side in the radial direction of the rotor core than the negative balance portion is; and
the negative balance portion is formed in a position avoiding a magnetic path generated by the rotor magnet.

2. The rotor according to claim 1, wherein:
the first balancing weight includes
a first fixing portion fixed to the end surface on one side in the axial direction of the rotor core, and
a first axial-direction extending portion extending from an end portion on an outer peripheral side of the first fixing portion toward one side in the axial direction of the rotor core.

3. The rotor according to claim 2, wherein:
the first balancing weight includes a first radial-direction extending portion extending from an end portion on a tip end side of the first axial-direction extending portion toward an outer side in a radial direction of the rotor core.

4. The rotor according to claim 3, wherein:
a length of the first radial-direction extending portion along the radial direction of the rotor core is longer than a length of the first axial-direction extending portion along the axial direction of the rotor core.

5. The rotor according to claim 2, wherein:
a thickness of the first fixing portion along the axial direction of the rotor core is thinner than a thickness of the second balancing weight along the axial direction of the rotor core.

6. The rotor according to claim 2, wherein:
the first fixing portion and the first axial-direction extending portion are formed into plate shapes.

7. The rotor according to claim 3, wherein:
the first fixing portion, the first axial-direction extending portion, and the first radial-direction extending portion are formed into plate shapes.

8. The rotor according to claim 2, wherein:
the first axial-direction extending portion is formed into a circular arc shape along a circumferential direction of the rotor core.

9. The rotor according to claim 3, wherein:
the first axial-direction extending portion and the first radial-direction extending portion are each formed into a circular arc shape along the circumferential direction of the rotor core.

10. The rotor according to claim 1, wherein:
the rotor core has a shaft insertion hole formed in a center portion of the rotor core and into which a shaft is inserted; and
the first balancing weight includes a positioning portion that positions the first balancing weight relative to the shaft.

11. The rotor according to claim 9, wherein:
the rotor includes a rotor magnet provided in a position further toward the outer side in the radial direction of the rotor core than the negative balance portion is; and
at least a portion of the negative balance portion is formed in a position corresponding to a center portion of the rotor magnet in a lateral width direction.

12. The rotor according to claim 9, wherein:
the rotor has a plurality of rotor magnets provided in positions further toward the outer side in the radial direction of the rotor core than the negative balance portion is;
the plurality of rotor magnets are arranged to be aligned in a circumferential direction of the rotor, and
at least a portion of the negative balance portion is formed in a position corresponding to a portion between adjacent rotor magnets.

13. The rotor according to claim 9, wherein:
the negative balance portion includes
a first negative balance portion open on an end surface on one side in the axial direction of the rotor core and
a second negative balance portion open on an end surface on the other side in the axial direction of the rotor core.

14. The rotor according to claim 2, wherein:
the rotor core has a magnet housing hole open on an end surface on one side in the axial direction of the rotor core and housing a rotor magnet;
the magnet housing hole is sealed by the first fixing portion; and
the first fixing portion has a magnet cooling hole formed in a position adjacent to the rotor magnet when viewed from the axial direction of the rotor core.

15. The rotor according to claim 1, wherein:
the second balancing weight includes
a second fixing portion fixed to an end surface on the other side in the axial direction of the rotor core,
a second axial-direction extending portion extending from an end portion on an outer peripheral side of the second fixing portion toward the other side in the axial direction of the rotor core, and
a second radial-direction extending portion extending from an end portion on a tip end side of the second axial-direction extending portion toward an outer side in a radial direction of the rotor core.

16. A rotor comprising:
a rotor core;
a first balancing weight provided on an end surface on one side in an axial direction of the rotor core; and
a second balancing weight provided on an end surface on another side in the axial direction of the rotor core, wherein:
the first balancing weight includes
a first fixing portion fixed to the end surface on one side in the axial direction of the rotor core, and
a first axial-direction extending portion extending from an end portion on an outer peripheral side of the first fixing portion toward one side in the axial direction of the rotor core; and
the second balancing weight is disposed on a side opposite the first axial-direction extending portion in a radial direction of the rotor core.

17. A compressor comprising:
a motor unit; and
a compressor unit provided on one side in an axial direction of the motor unit, wherein:
the motor unit includes
a motor housing,
a stator fixed to an inner side of the motor housing,
a rotor rotatably provided on an inner side of the stator, and
a shaft provided in a center portion of the rotor;
the compressor unit includes
a compressor housing assembled to the motor housing,
a fixed scroll fixed on an inner side of the compressor housing, and
a movable scroll fixed to the shaft in an eccentric state and turnably provided relative to the fixed scroll;
the rotor includes
a rotor core, and
a balancing weight provided on an end surface on one side in an axial direction of the rotor core;
the balancing weight includes
a fixing portion fixed to an end surface on one side in the axial direction of the rotor core,
an axial-direction extending portion extending from an end portion on one side in an axial direction of the fixing portion toward one side in the axial direction of the rotor core, and
a radial-direction extending portion extending from an end portion on a tip end side of the axial-direction extending portion toward an outer side in a radial direction of the rotor core; and
the radial-direction extending portion is disposed in a space between the stator and the compressor housing in an axial direction of the motor unit.

18. The compressor according to claim 17, wherein:
the rotor includes an imbalance correcting portion including the balancing weight; and
the imbalance correcting portion has an imbalance correction amount countering imbalance due to the movable scroll.

19. The compressor according to claim 17, wherein:
the stator includes a stator core disposed on the outer side in the radial direction of the rotor core;
a connecting portion between the axial-direction extending portion and the first fixing portion is positioned further toward an inner side than an external form of the rotor core is; and
an end portion on an outer peripheral side of the radial-direction extending portion is positioned further toward an inner side than an external form of the stator core is.
